(19) United States
(12) Patent Application Publication
(10) Pub. No.: US 2015/0046828 A1
(43) Pub. Date: Feb. 12, 2015

(54) CONTEXTUALIZING SENSOR, SERVICE AND DEVICE DATA WITH MOBILE DEVICES

(71) Applicant: Samsung Electronics Co., Ltd., Suwon-si (KR)

(72) Inventors: Prashant J. Desai, San Francisco, CA (US); Matthew Bice, San Francisco, CA (US); Benjamin A. Rottler, San Francisco, CA (US); Johan Olsson, San Francisco, CA (US); Magnus Borg, San Francisco, CA (US); Eun Young Park, San Francisco, CA (US); Golden Krishna, Berkeley, CA (US); Dennis Miloseski, Danville, CA (US); Wesley Yun, San Francisco, CA (US); Jeremy D. Baker, San Pablo, CA (US); Jeffery Jones, San Francisco, CA (US)

(21) Appl. No.: 14/449,091

(22) Filed: Jul. 31, 2014

Related U.S. Application Data
(60) Provisional application No. 61/892,037, filed on Oct. 17, 2013.
(60) Provisional application No. 61/870,982, filed on Aug. 28, 2013.
(60) Provisional application No. 61/879,020, filed on Sep. 17, 2013.
(60) Provisional application No. 61/863,843, filed on Aug. 8, 2013.

(51) Int. Cl. H04L 29/08; G06F 17/30; G06F 3/0484

(52) U.S. Cl. CPC H04L 67/22; G06F 3/04842; G06F 17/30867
USPC 715/739

(57) ABSTRACT

A method and system for contextualizing and presenting user data. The method includes collecting information comprising service activity data and sensor data from one or more electronic devices. The information is organized based on associated time for the collected information. One or more of content information and service information of potential interest are provided to the one or more electronic devices based on one or more of user context and user activity.

### CROSS-REFERENCE TO RELATED APPLICATIONS

This application claims the priority benefit of U.S. Provisional Patent Application Ser. No. 61/892,037, filed Oct. 17, 2013, U.S. Provisional Patent Application Ser. No. 61/870,982, filed Aug. 28, 2013, U.S. Provisional Patent Application Ser. No. 61/879,020, filed Sep. 17, 2013, and U.S. Provisional Patent Application Ser. No. 61/863,843, filed Aug. 8, 2013, all incorporated herein by reference in their entirety.

### TECHNICAL FIELD

One or more embodiments generally relate to collecting, contextualizing and presenting user activity data and, in particular, to collecting sensor and service activity information, archiving the information, contextualizing the information and presenting organized user activity data along with suggested content and services.

### BACKGROUND

With many individuals having mobile electronic devices (e.g., smartphones), information may be manually entered and organized by users for access, such as photographs, appointments and life events (e.g., walking, attending, birth of a child, birthdays, gatherings, etc.).

### SUMMARY

One or more embodiments generally relate to collecting, contextualizing and presenting user activity data. In one embodiment, a method includes collecting information comprising service activity data and sensor data from one or more electronic devices. The information may be organized based on associated time for the collected information. Additionally, one or more of content information and service information of potential interest are presented to the one or more electronic devices based on one or more of user context and user activity.

In one embodiment, a system is provided that includes an activity module for collecting information comprising service activity data and sensor data. Also included may be an organization module configured to organize the information based on associated time for the collected information. An information analyzer module may provide one or more of content information and service information of potential interest to one or more electronic devices based on one or more of user context and user activity.

In one embodiment a non-transitory computer-readable medium having instructions which when executed on a computer perform a method comprising: collecting information comprising service activity data and sensor data from one or more electronic devices. The information may be organized based on associated time for the collected information. Additionally, one or more of content information and service information of potential interest may be provided to the one or more electronic devices based on one or more of user context and user activity.

In one embodiment, a graphical user interface (GUI) displayed on a display of an electronic device includes one or more timeline events related to information comprising service activity data and sensor data collected from at least the electronic device. The GUI may further include one or more of content information and selectable service categories of potential interest to a user that are based on one or more of user context and user activity associated with the one or more timeline events.

In one embodiment, a display architecture for an electronic device includes a timeline comprising a plurality of content elements and one or more content elements of potential user interest. In one embodiment, the plurality of time-based elements comprise one or more of event information, communication information and contextual alert information, and the plurality of time-based elements are displayed in a particular chronological order. In one embodiment, the plurality of time-based elements are expandable to provide expanded information based on a received recognized user action.

In one embodiment, a wearable electronic device includes a processor, a memory coupled to the processor, a curved display and one or more sensors. In one embodiment, the sensors provide sensor data to an analyzer module that determines context information and provides one or more of content information and service information of potential interest to a timeline module of the wearable electronic device using the context information that is determined based on the sensor data and additional information received from one or more of service activity data and additional sensor data from a paired host electronic device. In one embodiment, the timeline module organizes content for a timeline interface on the curved display.

These and other aspects and advantages of one or more embodiments will become apparent from the following detailed description, which, when taken in conjunction with the drawings, illustrate by way of example the principles of the one or more embodiments.

### BRIEF DESCRIPTION OF THE DRAWINGS

For a fuller understanding of the nature and advantages of the embodiments, as well as a preferred mode of use, reference should be made to the following detailed description read in conjunction with the accompanying drawings, in which:

FIG. 1 shows a schematic view of a communications system, according to an embodiment.

FIG. 2 shows a block diagram of architecture for a system including a server and one or more electronic devices, according to an embodiment.

FIG. 3 shows an example system environment, according to an embodiment.

FIG. 4 shows an example of organizing data into an archive, according to an embodiment.

FIG. 5 shows an example timeline view, according to an embodiment.

FIG. 6 shows example commands for gestural navigation, according to an embodiment.

FIGS. 7A-D show examples for expanding events on a timeline graphical user interface (GUI), according to an embodiment.

FIG. 8 shows an example for flagging events, according to an embodiment.

FIG. 9 shows examples for dashboard detail views, according to an embodiment.

FIG. 10 shows an example of service and device management, according to an embodiment.

FIGS. 11A-D show examples of service management for application/services discovery, according to one embodiment.

FIGS. 12A-D show examples of service management for application/service streams, according to one embodiment.

FIGS. 13A-D show examples of service management for application/service user interests, according to one embodiment.

FIG. 14 shows an example overview for mode detection, according to one embodiment.

FIG. 15 shows an example process for aggregating/collecting and displaying user data, according to one embodiment.

FIG. 16 shows an example process for service management through an electronic device, according to one embodiment.

FIG. 17 shows an example timeline and slides, according to one embodiment.

FIG. 18 shows an example process information architecture, according to one embodiment.

FIG. 19 shows example active tasks, according to one embodiment.

FIG. 20 shows an example of timeline logic with incoming slides and active tasks, according to one embodiment.

FIG. 21A-B show an example detailed timeline, according to one embodiment.

FIG. 22A-B show an example of timeline logic with example slide categories, according to one embodiment.

FIG. 23 shows examples of timeline push notification slide categories, according to one embodiment.

FIG. 24 shows examples of timeline pull notifications, according to one embodiment.

FIG. 25 shows an example process for routing an incoming slide, according to one embodiment.

FIG. 26 shows an example wearable device block diagram, according to one embodiment.

FIG. 27 shows example notification functions, according to one embodiment.

FIG. 28 shows example input gestures for interacting with a timeline, according to one embodiment.

FIG. 29 shows an example process for creating slides, according to one embodiment.

FIG. 30 shows an example of slide generation using a template, according to one embodiment.

FIG. 31 shows an example of contextual voice commands based on a displayed slide, according to one embodiment.

FIG. 32 shows an example block diagram for a wearable device and host device/smart phone, according to one embodiment.

FIG. 33 shows an example process for receiving commands on a wearable device, according to one embodiment.

FIG. 34 shows an example process for motion based gestures for a mobile/wearable device, according to one embodiment.

FIG. 35 shows an example smart alert using haptic elements, according to one embodiment.

FIG. 36 shows an example process for recording a customized haptic pattern, according to one embodiment.

FIG. 37 shows an example process for a wearable device receiving a haptic recording, according to one embodiment.

FIG. 38 shows an example diagram of a haptic recording, according to one embodiment.

FIG. 39 shows an example single axis force sensor for recording haptic input, according to one embodiment.

FIG. 40 shows an example touch screen for haptic input, according to one embodiment.

FIG. 41 shows an example block diagram for a wearable device system, according to one embodiment.

FIG. 42 shows a block diagram of a process for contextualizing and presenting user data, according to one embodiment.

FIG. 43 is a high-level block diagram showing an information processing system comprising a computing system implementing one or more embodiments.

### DETAILED DESCRIPTION

The following description is made for the purpose of illustrating the general principles of one or more embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

Embodiments relate to collecting sensor and service activity information from one or more electronic devices (e.g., mobile electronic devices such as smart phones, wearable devices, tablet devices, cameras, etc.), archiving the information, contextualizing the information and providing/presenting organized user activity data along with suggested content information and service information. In one embodiment, the method includes collecting information comprising service activity data and sensor data from one or more electronic devices. The information may be organized based on associated time for the collected information. Based on one or more of user context and user activity, one or more of content information and service information of potential interest may be provided to one or more electronic devices as described herein.

One or more embodiments collect and organizes an individual's “life events,” captured from an ecosystem of electronic devices, into a timeline life log of event data, which may be filtered through a variety of “lenses,” filters, or an individual's specific interest areas. In one embodiment, life events captured are broad in scope, and deep in content richness. In one embodiment, life activity events from a wide variety of services (e.g., third party services, cloud-based services, etc.) and other electronic devices in a personal ecosystem (e.g., electronic devices used by a user, such as a smart phone a wearable device, a tablet device, a smart television device, other computing devices, etc.) are collected and organized.

In one embodiment, life data (e.g., from user activity with devices, sensor data from devices used, third party services, cloud-based services, etc.) is captured by the combination of sensor data from both a mobile electronic device (e.g., a smartphone) and a wearable electronic device, as well as services activity (i.e., using a service, such as a travel advising service, information providing service, restaurant advising service, review service, financial service, guidance service, etc.) and may automatically and dynamically be visualized into a dashboard GUI based on a user's specified interest area. One or more embodiments, provide a large set of modes within which life events may be organized (e.g., walking, driving, flying, biking, transportation services such as bus, train, etc.). These embodiments may not solely rely on sensor data from a hand held device, but also leverages sensor information from a wearable companion device.

One or more embodiments are directed to an underlying service to accompany a wearable device, which may take the form of a companion application to help manage how different types of content is seen by the user and through which touchpoints on a GUI. These embodiments may provide a journey view that is unique to an electronic device is that aggregating a variety of different life events, ranging from using services (e.g., service activity data) and user activity (e.g., sensor data, electronic device activity data), and placing the events in a larger context within modes. The embodiments may bring together a variety of different information into singular view by leveraging sensor information to supplement service information and content information/data (e.g., text, photos, links, video, audio, etc.).

One or more embodiments highlight insights about a user's life based on their actual activity, allowing the users to learn about themselves. One embodiment provides a central touchpoint for managing services and how they are experienced. One or more embodiments provide a method for suggesting different types of services (i.e., offered by third-parties, offered by cloud-based services, etc.) and content that an electronic device user may subscribe to, which may be contextually tailored to the user (i.e., of potential interest). In one example embodiment, based on different types of user input, the user may see service suggestions based on user activity, e.g., where the user is checking in (locations, establishments, etc.), and what activities they are doing (e.g., various activity modes).

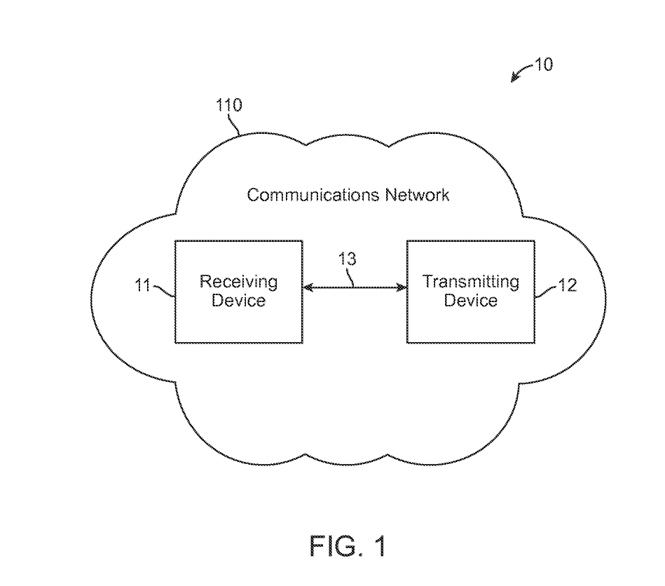

FIG. 1 is a schematic view of a communications system 10, in accordance with one embodiment. Communications system 10 may include a communications device that initiates an outgoing communications operation (transmitting device 12) and a communications network 110, which transmitting device 12 may use to initiate and conduct communications operations with other communications devices within communications network 110. For example, communications system 10 may include a communication device that receives the communications operation from the transmitting device 12 (receiving device 11). Although communications system 10 may include multiple transmitting devices 12 and receiving devices 11, only one of each is shown in FIG. 1 to simplify the drawing.

Any suitable circuitry, device, system or combination of these (e.g., a wireless communications infrastructure including communications towers and telecommunications servers) operative to create a communications network may be used to create communications network 110. Communications network 110 may be capable of providing communications using any suitable communications protocol. In some embodiments, communications network 110 may support, for example, traditional telephone lines, cable television, Wi-Fi (e.g., an IEEE 802.11 protocol), Bluetooth®, high frequency systems (e.g., 900 MHz, 2.4 GHz, and 5.6 GHz communication systems), infrared, other relatively localized wireless communication protocol, or any combination thereof. In some embodiments, the communications network 110 may support protocols used by wireless and cellular phones and personal email devices. Such protocols may include, for example, GSM, GSM plus EDGE, CDMA, quadband, and other cellular protocols. In another example, a long range communications protocol can include Wi-Fi and protocols for placing or receiving calls using VOIP, LAN, WAN, or other TCP-IP based communication protocols. The transmitting device 12 and receiving device 11, when located within communications network 110, may communicate over a bidirectional communication path such as path 13, or over two unidirectional communication paths. Both the transmitting device 12 and receiving device 11 may be capable of initiating a communications operation and receiving an initiated communications operation.

The transmitting device 12 and receiving device 11 may include any suitable device for sending and receiving communications operations. For example, the transmitting device 12 and receiving device 11 may include mobile telephone devices, television systems, cameras, camcorders, a device with audio video capabilities, tablets, wearable devices, and any other device capable of communicating wirelessly (with or without the aid of a wireless-enabling accessory system) or via wired pathways (e.g., using traditional telephone wires). The communications operations may include any suitable form of communications, including for example, voice communications (e.g., telephone calls), data communications (e.g., e-mails, text messages, media messages), video communication, or combinations of these (e.g., video conferences).

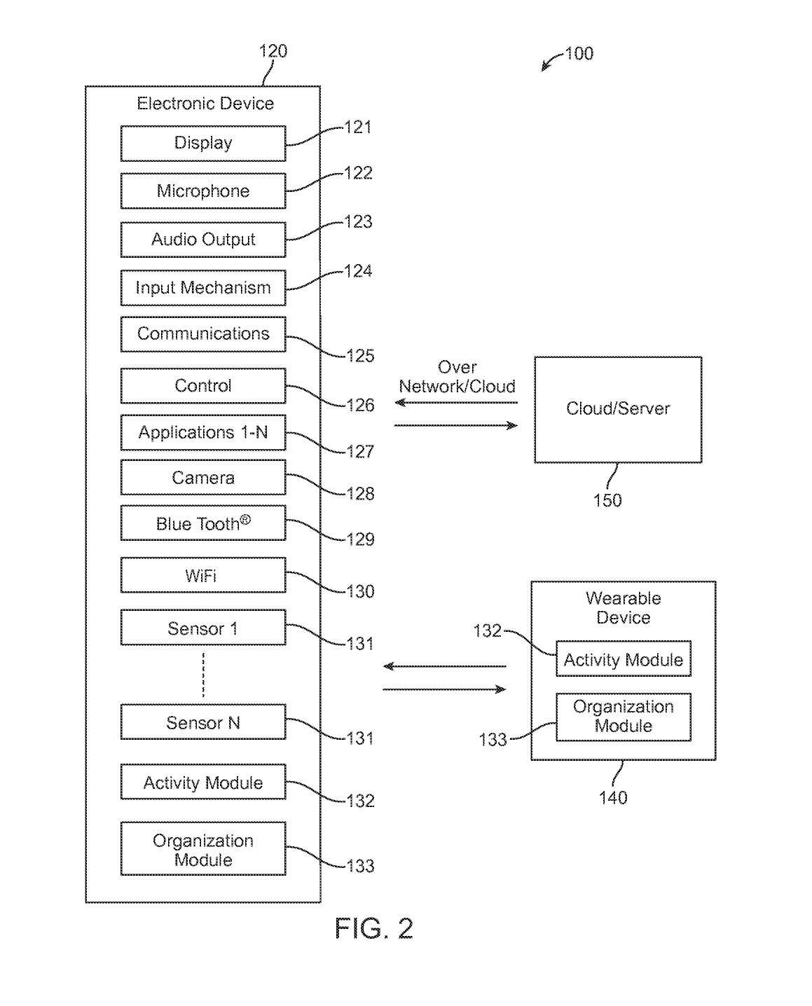

FIG. 2 shows a functional block diagram of an architecture system 100 that may be used for providing a service or application for collecting sensor and service activity information, archiving the information, contextualizing the information and presenting organized user activity data along with suggested content and services using one or more electronic devices 120 and wearable device 140. Both the transmitting device 12 and receiving device 11 may include some or all of the features of the electronics device 120 and/or the features of the wearable device 140. In one embodiment, the electronic device 120 and the wearable device 140 may communicate with one another, synchronize data, information, content, etc. with one another and provide complimentary or similar features.

In one embodiment, the electronic device 120 may comprise a display 121, a microphone 122, an audio output 123, an input mechanism 124, communications circuitry 125, control circuitry 126, Applications 1−N 127, a camera module 128, a Bluetooth® module 129, a Wi-Fi module 130 and sensors 1 to N 131 (N being a positive integer), activity module 132, organization module 133 and any other suitable components. In one embodiment, applications 1−N 127 are provided and may be obtained from a cloud or server 150, a communications network 110, etc., where N is a positive integer equal to or greater than 1. In one embodiment, the system 100 includes a context aware query application that works in combination with a cloud-based or server-based subscription service to collect evidence and context information, query for evidence and context information, and present requests for queries and answers to queries on the display 121. In one embodiment, the wearable device 140 may include a portion or all of the features, components and modules of electronic device 120.

In one embodiment, all of the applications employed by the audio output 123, the display 121, input mechanism 124, communications circuitry 125, and the microphone 122 may be interconnected and managed by control circuitry 126. In one example, a handheld music player capable of transmitting music to other tuning devices may be incorporated into the electronics device 120 and the wearable device 140.

In one embodiment, the audio output 123 may include any suitable audio component for providing audio to the user of electronics device 120 and the wearable device 140. For example, audio output 123 may include one or more speakers (e.g., mono or stereo speakers) built into the electronics device 120. In some embodiments, the audio output 123 may include an audio component that is remotely coupled to the electronics device 120 or the wearable device 140. For example, the audio output 123 may include a headset, headphones, or earbuds that may be coupled to communications device with a wire (e.g., coupled to electronics device 120/wearable device 140 with a jack) or wirelessly (e.g., Bluetooth® headphones or a Bluetooth® headset).

In one embodiment, the display 121 may include any suitable screen or projection system for providing a display visible to the user. For example, display 121 may include a screen (e.g., an LCD screen) that is incorporated in the electronics device 120 or the wearable device 140. As another example, display 121 may include a movable display or a projecting system for providing a display of content on a surface remote from electronics device 120 or the wearable device 140 (e.g., a video projector). Display 121 may be operative to display content (e.g., information regarding communications operations or information regarding available media selections) under the direction of control circuitry 126.

In one embodiment, input mechanism 124 may be any suitable mechanism or user interface for providing user inputs or instructions to electronics device 120 or the wearable device 140. Input mechanism 124 may take a variety of forms, such as a button, keypad, dial, a click wheel, or a touch screen. The input mechanism 124 may include a multi-touch screen.

In one embodiment, communications circuitry 125 may be any suitable communications circuitry operative to connect to a communications network (e.g., communications network 110, FIG. 1) and to transmit communications operations and media from the electronics device 120 or the wearable device 140 to other devices within the communications network. Communications circuitry 125 may be operative to interface with the communications network using any suitable communications protocol such as, for example, Wi-Fi (e.g., an IEEE 802.11 protocol), Bluetooth®, high frequency systems (e.g., 900 MHz, 2.4 GHz, and 5.6 GHz communication systems), infrared, GSM, GSM plus EDGE, CDMA, quadband, and other cellular protocols, VOIP, TCP-IP, or any other suitable protocol.

In some embodiments, communications circuitry 125 may be operative to create a communications network using any suitable communications protocol. For example, communications circuitry 125 may create a short-range communications network using a short-range communications protocol to connect to other communications devices. For example, communications circuitry 125 may be operative to create a local communications network using the Bluetooth® protocol to couple the electronics device 120 with a Bluetooth® headset.

In one embodiment, control circuitry 126 may be operative to control the operations and performance of the electronics device 120 or the wearable device 140. Control circuitry 126 may include, for example, a processor, a bus (e.g., for sending instructions to the other components of the electronics device 120 or the wearable device 140), memory, storage, or any other suitable component for controlling the operations of the electronics device 120 or the wearable device 140. In some embodiments, a processor may drive the display and process inputs received from the user interface. The memory and storage may include, for example, cache, Flash memory, ROM, and/or RAM/DRAM. In some embodiments, memory may be specifically dedicated to storing firmware (e.g., for device applications such as an operating system, user interface functions, and processor functions). In some embodiments, memory may be operative to store information related to other devices with which the electronics device 120 or the wearable device 140 perform communications operations (e.g., saving contact information related to communications operations or storing information related to different media types and media items selected by the user).

In one embodiment, the control circuitry 126 may be operative to perform the operations of one or more applications implemented on the electronics device 120 or the wearable device 140. Any suitable number or type of applications may be implemented. Although the following discussion will enumerate different applications, it will be understood that some or all of the applications may be combined into one or more applications. For example, the electronics device 120 and the wearable device 140 may include an automatic speech recognition (ASR) application, a dialog application, a map application, a media application (e.g., QuickTime, MobileMusic.app, or MobileVideo.app, YouTube®, etc.), social networking applications (e.g., Facebook®, Twitter®, etc.), an Internet browsing application, etc. In some embodiments, the electronics device 120 and the wearable device 140 may include one or multiple applications operative to perform communications operations. For example, the electronics device 120 and the wearable device 140 may include a messaging application, a mail application, a voicemail application, an instant messaging application (e.g., for chatting), a videoconferencing application, a fax application, or any other suitable application for performing any suitable communications operation.

In some embodiments, the electronics device 120 and the wearable device 140 may include a microphone 122. For example, electronics device 120 and the wearable device 140 may include microphone 122 to allow the user to transmit audio (e.g., voice audio) for speech control and navigation of applications 1−N 127, during a communications operation or as a means of establishing a communications operation or as an alternative to using a physical user interface. The microphone 122 may be incorporated in the electronics device 120 and the wearable device 140, or may be remotely coupled to the electronics device 120 and the wearable device 140. For example, the microphone 122 may be incorporated in wired headphones, the microphone 122 may be incorporated in a wireless headset, the microphone 122 may be incorporated in a remote control device, etc.

In one embodiment, the camera module 128 comprises one or more camera devices that include functionality for capturing still and video images, editing functionality, communication interoperability for sending, sharing, etc. photos/videos, etc.

In one embodiment, the Bluetooth® module 129 comprises processes and/or programs for processing Bluetooth® information, and may include a receiver, transmitter, transceiver, etc.

In one embodiment, the electronics device 120 and the wearable device 140 may include multiple sensors 1 to N 131, such as accelerometer, gyroscope, microphone, temperature, light, barometer, magnetometer, compass, radio frequency (RF) identification sensor, etc. In one embodiment, the multiple sensors 1−N 131 provide information to the activity module 132.

In one embodiment, the electronics device 120 and the wearable device 140 may include any other component suitable for performing a communications operation. For example, the electronics device 120 and the wearable device 140 may include a power supply, ports, or interfaces for coupling to a host device, a secondary input mechanism (e.g., an ON/OFF switch), or any other suitable component.

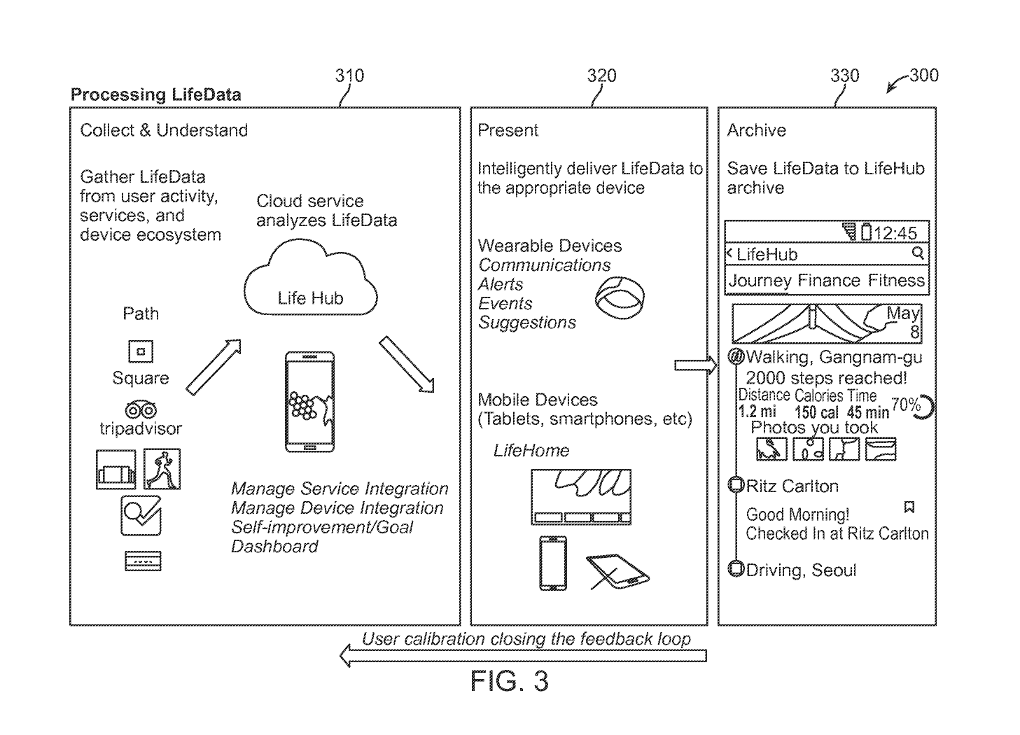

FIG. 3 shows an example system 300, according to an embodiment. In one embodiment, block 310 shows collecting and understanding the data that is collected. Block 320 shows the presentation of data (e.g., life data) to electronic devices, such as an electronic device 120 (FIG. 2) and wearable device 140. Block 330 shows archiving of collected data to a LifeHub (i.e., cloud based system/server, network, storage device, etc.). In one embodiment, system 300 shows an overview of a process for how a user's data (e.g., LifeData) progresses through system 300 using three aspects: collect and understand in block 310, present in block 320, and archive in block 330.

In block 310, the collect and understand process gathers data (e.g., Life Data) from user activity, third party services information from a user device(s) (e.g., an electronic device 120, and/or wearable device 140), and other devices in the user's device ecosystem. In one embodiment, the data may be collected by the activity module 132 (FIG. 2) of the electronic device 120 and/or the wearable device 140. The service activity information may include information on what the user was viewing, reading, searching for, watching, etc. For example, if a user is using a travel service (e.g., a travel guide service/Application, a travel recommendation service/application, etc.), the service activity information may include: the hotels/motels viewed, cities reviewed, airlines, dates, car rental information, etc., reviews read, search criteria entered (e.g., price, ratings, dates, etc.), comments left, ratings made, etc. In one embodiment, the collected data may be analyzed in the cloud/server 150. In one embodiment, the collecting and analysis may be managed from a user facing touchpoint in a mobile device (e.g., electronic device 120, wearable device 140, etc.). In one embodiment, the management may include service integration and device integration as described below.

In one embodiment, the process in system 300 may intelligently deliver appropriate data (e.g., Life Data) to a user through wearable devices (e.g., wearable device 140) or mobile devices (e.g., electronic device 120). These devices may comprise a device ecosystem along with other devices. The presentation in block 320 may be performed in the form of alerts, suggestions, events, communications, etc., which may be handled via graphics, text, sound, speech, vibration, light, etc., in the form of slides, cards, data or content time-based elements, objects, etc. The data comprising the presentation form may be delivered through various methods of communications interfaces, e.g., Bluetooth®, Near Field Communications (NFC), WiFi, cellular, broadband, etc.

In one embodiment, the archive process in block 330 may utilize the data from third parties and user activities, along with data presented to a user and interacted with. In one embodiment, the process may compile and process the data, then generate a dashboard in a timeline representation (as shown in block 330) or interest focused dashboards allowing a user to view their activities. The data may be archived/saved in the cloud/server 150, on an electronic device 120 (and/or wearable device 140) or any combination.

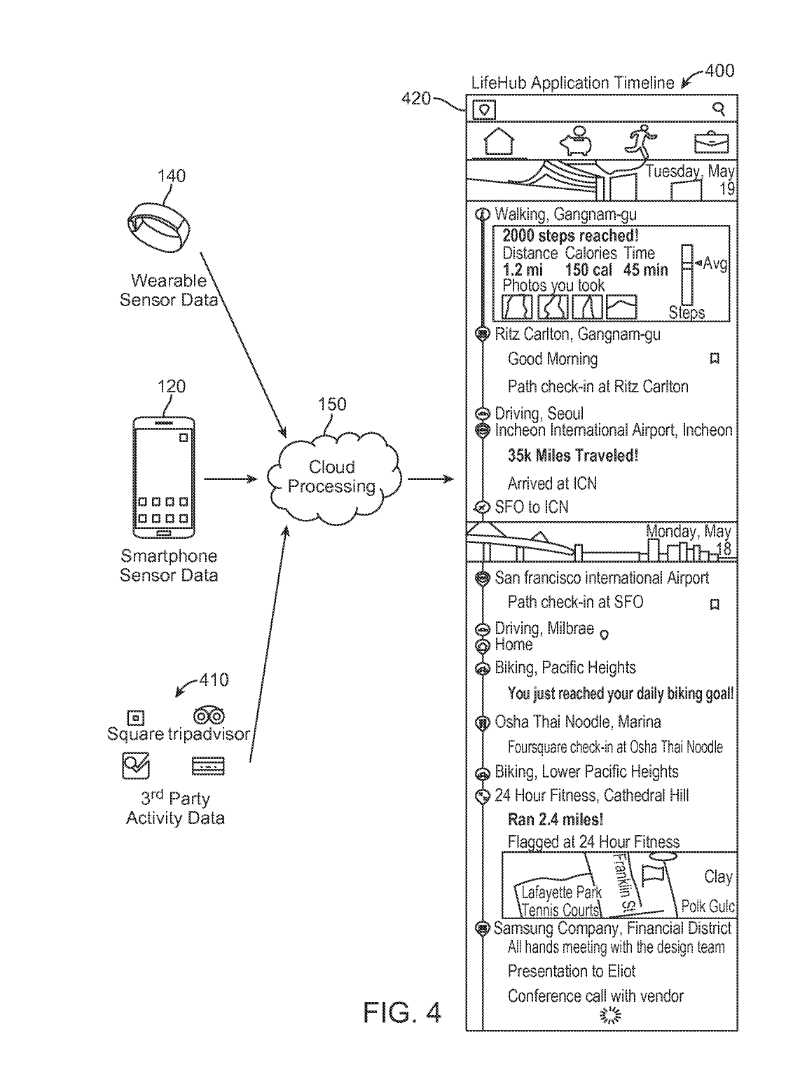

FIG. 4 shows an example 400 of organizing data into an archive, according to an embodiment. In one embodiment, the processing of the data into an archived timeline format 420 may occur in the cloud 150 and off the electronic device 120 and the wearable device 140. Alternatively, the electronic device 120 may process the data and generate the archive, or any combination of one or more of the electronic device 120, the wearable device 140 and the cloud 150 may process the data and generate the archive. As shown, the data is collected from the activity services 410, the electronic device 120 (e.g., data, content, sensor data, etc.), and the wearable device 140 (e.g., data, content, sensor data, etc.).

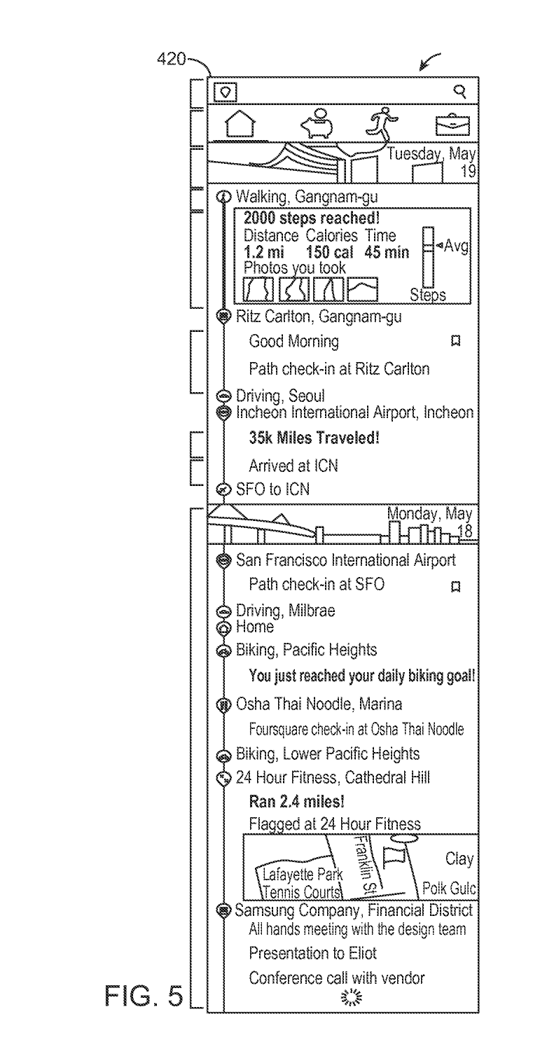

FIG. 5 shows an example timeline view 450, according to an embodiment. In one embodiment, the timeline 420 view 450 includes an exemplary journal or archive timeline view. A user's archived daily activity may be organized on the timeline 420. As described above, the archive is populated with activities or places the user has actually interacted with, providing a consolidated view of the user's life data. In one embodiment, the action bar at the top of the timeline 420 provides for navigation to the home/timeline view, or interest specific views, as will be described below.

In one example embodiment, the header indicates the current date being viewed, and includes image captured by a user, or sourced from a third-party based on user activity or location. In one example, the context is a mode (e.g., walking). In one embodiment, the “now,” or current life events that is being logged is always expanded to display additional information, such as event title, progress, and any media either consumed or captured (e.g., music listened to, pictures captured, books read, etc.). In one example embodiment, as shown in the view 450, the user walking around a city.

In one embodiment, the past events include logged events from the current day. In an example embodiment, as shown in view 450, the user interacted with two events while at the Ritz Carlton. Either of these events may be selected and expanded to see deeper information (as described below). Optionally, other context may be used, such as location. In one embodiment, the wearable device 140 achievement events are highlighted in the timeline with a different icon or symbol. In one example, the user may continue to scroll down to previous days of the life events for timeline 420 information. Optionally, upon reaching the bottom of the timeline 420, more content is automatically loaded into view 450, allowing for continuous viewing.

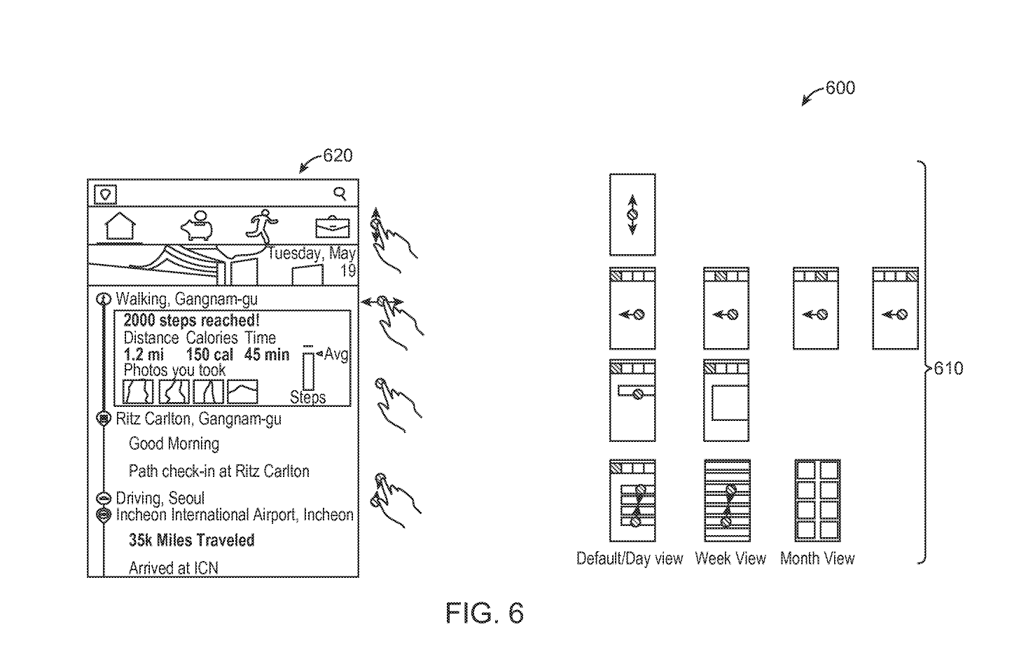

FIG. 6 shows example 600 commands for gestural navigation, according to an embodiment. As shown, the example timeline 620 a user facing touchpoint may be navigable through interpreting gesture inputs 610 from the user. In one example embodiment, such inputs may be interpreted to be scrolling, moving between interest areas, expansion, etc. In one embodiment, gestures such as pinching in or out using multiple fingers may provide navigation crossing category layers. In one example embodiment, in a display view for a single day, the pinch gesture may transition to a weekly view, and again for a monthly view, etc. Similarly, the opposing motion (e.g., multiple finger gesture to zoom in) may zoom in from either the weekly view, monthly view, etc.

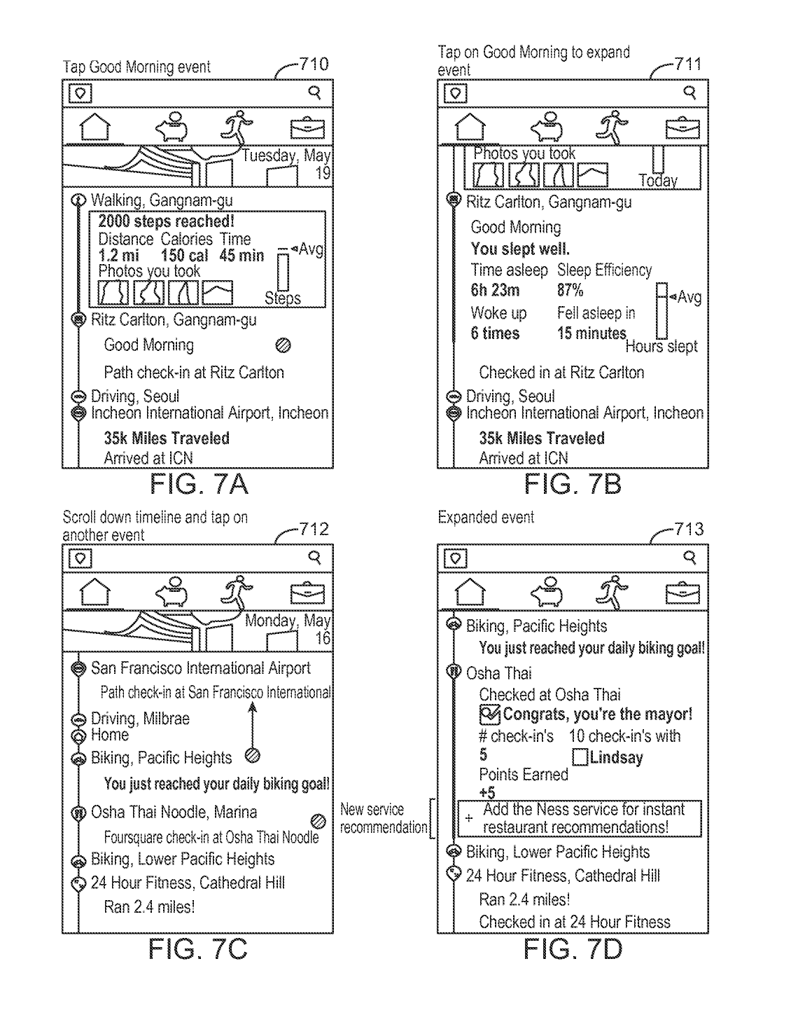

FIGS. 7A-D show examples 710, 711, 712 and 713, respectively, for expanding events (e.g., slides/time-based elements) on a timeline GUI, according to an embodiment. In one embodiment, the examples 710-713 show how details for events on the archived timeline may be shown. In one example embodiment, such expansions may show additional details related to the event, such as recorded and analyzed sensor data, applications/service/content suggestions, etc. Receiving a recognized input (e.g., a momentary force, tap touch, etc.) on or activating a user facing touchpoint for any LifeData event in the timeline may expand the event to view detailed content. In one embodiment, example 710 shows the result of a recognizing a received input or activation command on a “good morning” event. In example 711, the good morning event is shown in the expanded view. In example 712, the timeline is scrolled down via a recognized input or activation command another event is expanded via a received recognized input or activating the touchpoint. In example 713, the expanded event is displayed.

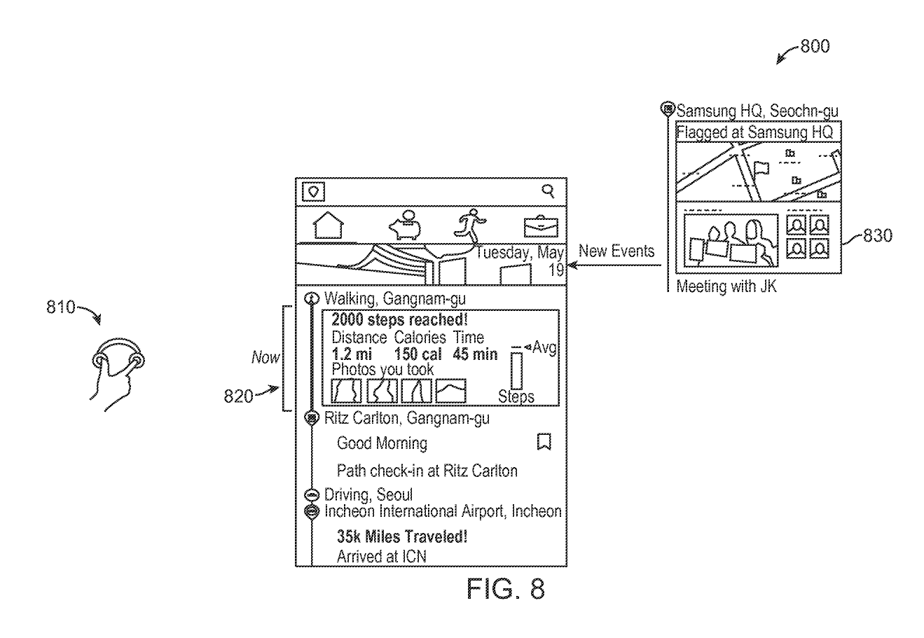

FIG. 8 shows an example 800 for flagging events, according to an embodiment. In one example embodiment, a wearable device 140 (FIG. 2) may have predetermined user actions or gestures (e.g., squeezing the band) which, when received may register a user flagging an event. In one embodiment, the system 300 (FIG. 3) may detect a gesture from a user on a paired wearable device 140. For example, the user may squeeze 810 the wearable device 140 to initiate flagging. In one embodiment, flagging captures various data points into a single event 820, such as locations, pictures or other images, nearby friends or family, additional events taking place at the same location, etc. The system 300 may determine the data points to be incorporated into the event through contextual relationships, such as pictures taken during an activity, activity data (time spent, distance traveled, steps taken, etc.), activity location, etc. In one embodiment, flagged events may be archived into the timeline 420 (FIG. 4) and appear as highlighted events 830 (e.g., via a particular color, a symbol, an icon, an animated symbol/color/icon, etc.).

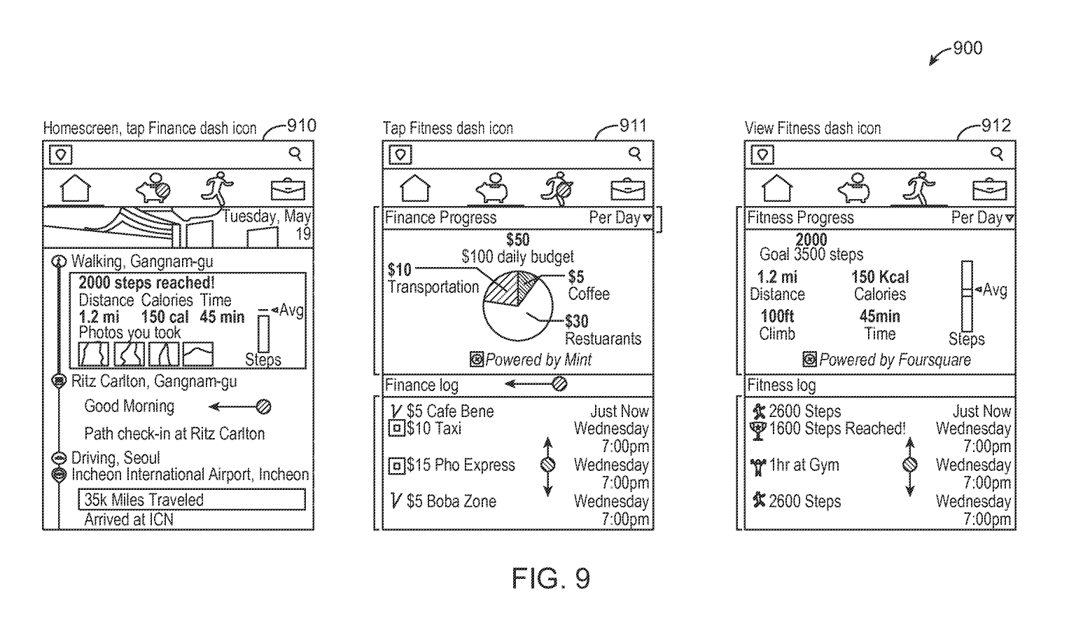

FIG. 9 shows an example 900 for dashboard detail views, according to an embodiment. In one embodiment, the examples 910, 911 and 912 show example detail views of the dashboard that is navigable by a user through the timeline 420 (FIG. 4) GUI. The dashboard detail view may allow users to view aggregated information for specific interests. In one example embodiment, the specific interests may be selectable from the user interface on the timeline 420 by selecting the appropriate icon, link, symbol, etc. In one example, the interests may include finance, fitness, travel, etc. The user may select the finance symbol or icon on the timeline 420 as shown in the example view 910. In example 911 the finance interest view is shown, which may show the user an aggregated budget. In one example embodiment, the budget may be customized for various time periods (e.g., daily, weekly, monthly, custom periods, etc.). In one embodiment, the dashboard may show a graphical breakdown or a list of expenditures, or any other topic related to finance.

In one example embodiment, in the example view 912 a fitness dashboard is shown based on a user selection of a fitness icon or symbol. In one embodiment, the fitness view may comprise details of activities performed, metrics for the various activities (e.g., steps taken, distance covered, time spent, calories burned, etc.), user's progression towards a target, etc. In other example embodiments, travel details may be displayed based on a travel icon or symbol, which may show places the user has visited either local or long distance, etc. In one embodiment, the interest categories may be extensible or customizable. For example, the interest categories may contain data displayed or detailed to a further level of granularity by pertaining to a specific interest, such as hiking, golf, exploring, sports, hobbies, etc.

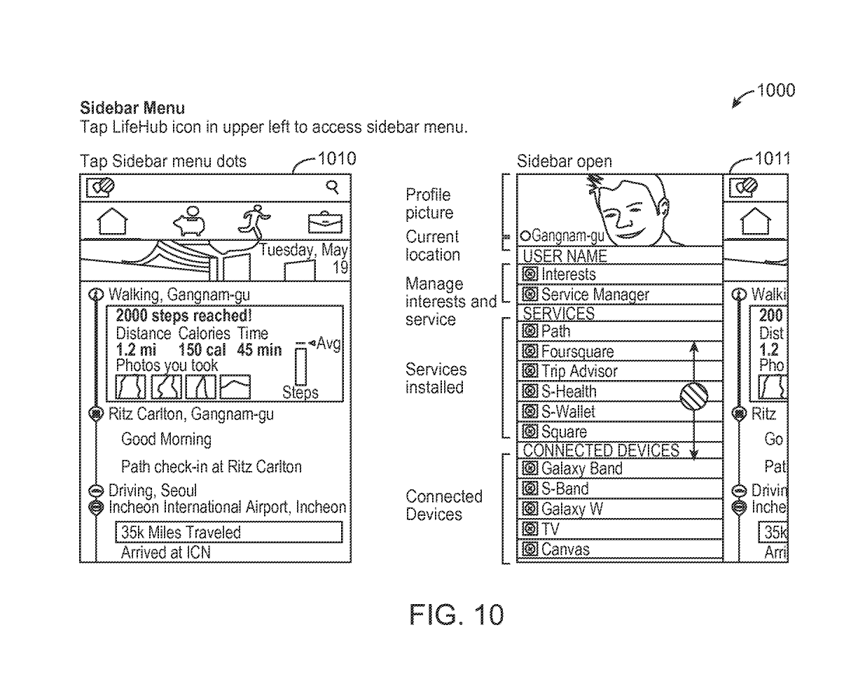

FIG. 10 shows an example 1000 of service and device management, according to an embodiment. In one embodiment, the user facing touchpoint provides for managing services and devices as described further herein. In one example, upon selecting (e.g., touching, tapping) a side bar icon or symbol on the example timeline 1010, a management view 1011 opens showing different services and devices that may be managed by a user.

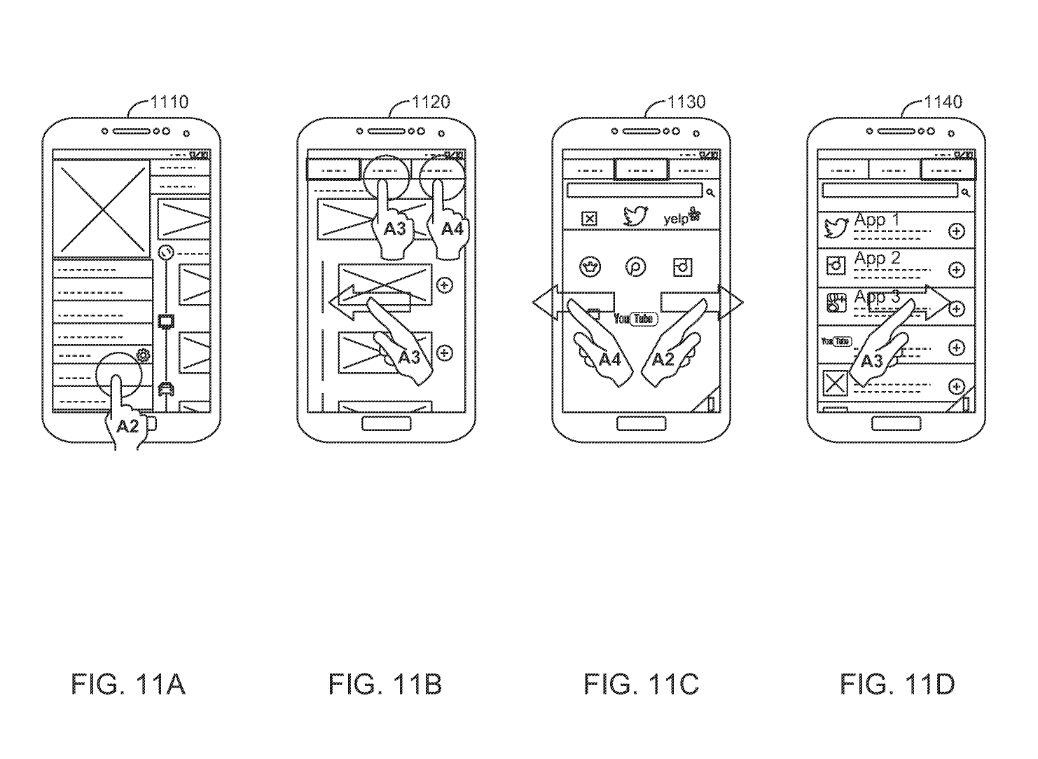

FIGS. 11A-D show example views 1110, 1120, 1130 and 1140 of service management for application/services discovery, according to one embodiment. The examples shown illustrate exemplary embodiments for enabling discovery of relevant applications or services. In one embodiment, the timeline 420 (FIG. 4) GUI may display recommendations for services to be incorporated into the virtual dashboard streams described above. The recommendations may be separated into multiple categories. In one example, one category may be personal recommendations based on context (e.g., user activity, existing applications/services, location, etc.). In another example, a category may be the most popular applications/services added to streams. In yet another example, a third category may include new notable applications/services. These categories may display the applications in various formats including, a sample format similar to how the application/service would be displayed in the timeline, a grid view, a list view, etc.

In one embodiment, on selection of a category, a service or application may display preview details with additional information about the service or application. In one embodiment, if the application or service has already been installed, the service management may merely integrate the application into the virtual dashboards. In one embodiment, example 1110 shows a user touching a drawer for opening the drawer on the timeline 420 space GUI. The drawer may contain quick actions. In one example embodiment, one section provides for the user accessing actions, such as Discover, Device Manager, etc. In one embodiment, tapping “Discover” takes the user to new screen (e.g., transitioning from example 1110 to example 1120).

In one embodiment, example 1120 shows a “Discover” screen that contains recommendations for streams that may be sorted by multiple categories, such as For You, Popular, and What's New. In one embodiment, the Apps icons/symbols are formatted similarly to a Journey view, allowing users to “sample” the streams. In one embodiment, users may tap an “Add” button on the right to add a stream. As shown in the example, the categories may be relevant to the user similar to the examples provided above.

In one embodiment, example 1120 shows that a user may tap a tab to go directly to that tab or swipe between tabs one by one. As described above, the categories may display the applications in various formats. In example 1130, the popular tab displays available streams in a grid format and provides a preview when an icon or symbol is tapped. In example 1140, the What's New tab, displays available services or applications in a list format with each list item accompanied by a short description and an “add” button.

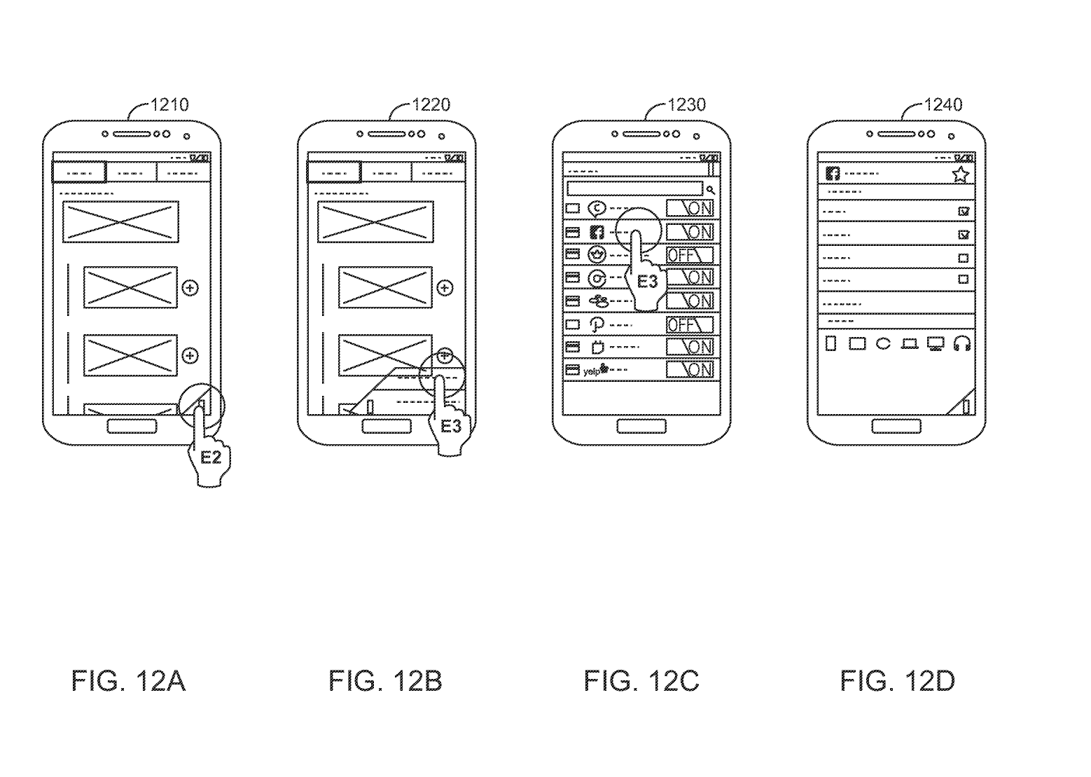

FIGS. 12A-D show examples 1210, 1220, 1230 and 1240 of service management for application/service streams, according to one embodiment. In one embodiment, the examples 1210-1240 show that users may edit the virtual dashboard or streams. A user facing touchpoint may provide the user the option to activate or deactivate applications, which are shown through the virtual dashboard. The touchpoint may also provide for the user to choose which details an application shows on the virtual dashboard and on which associated device (e.g., electronic device 120, wearable device 140, etc.) in the device ecosystem.

In one embodiment, in example 1210 a received and recognized input or activation (e.g., a momentary force, an applied force that is moved/dragged on a touchpoint, etc.) on the drawer icon is received and recognized. Optionally, the drawer icon may be a full-width toolbar that invokes an option menu. In example 1220, an option menu may be displayed with, for example, Edit My Stream, Edit My Interests, etc. In one example, the Edit My Streams in example 1220 is selected based on a received and recognized action (e.g., a momentary force on a touchpoint, user input that is received and recognized, etc.). In example 1230 (the Streams screen), the user may be provided with a traditional list of services, following the selection to edit the streams. In one example embodiment, a user may tap on the switch to toggle a service on or off. In one embodiment, features/content offered at this level may be pre-canned. Optionally, details of the list item may be displayed when receiving an indication of a received and recognized input, command or activation on a touchpoint (e.g., the user tapped on the touchpoint) for the list item. In one embodiment, the displayed items may include an area allowing each displayed item to be “grabbed” and dragged to reorder the list (e.g., top being priority). In example 1230, the grabbable area is located at the left of each item.

In one embodiment, example view 1240 shows a detail view of an individual stream and allow the user to customize that stream. In one example embodiment, the user may choose which features/content they desire to see and on which device (e.g., electronic device 120, wearable device 140, FIG. 2). In one embodiment, features/content that cannot be turned off are displayed but not actionable.

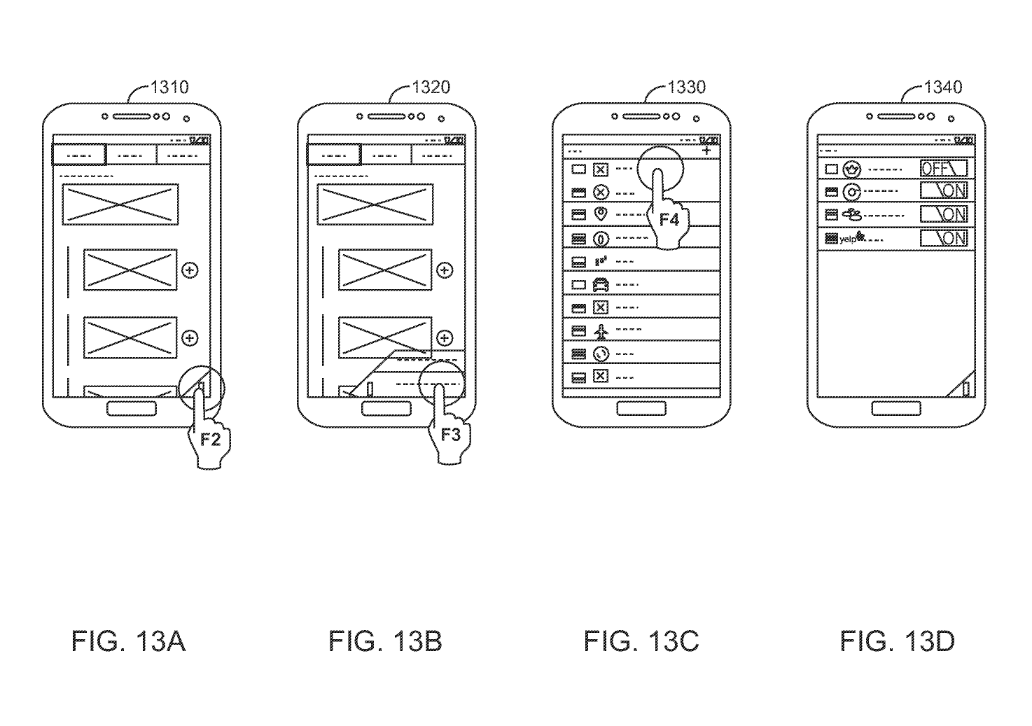

FIGS. 13A-D show examples 1310, 1320, 1330 and 1340 of service management for application/service user interests, according to one embodiment. One or more embodiments provide for management of user interests on the timeline 420 (FIG. 4). In one embodiment, users may add, delete, reorder, modify, etc. interest categories. Optionally, users may also customize what may be displayed in the visual dashboards of the interest (e.g., what associated application/services are displayed along with details). Additionally, management as described may comprise part of the user feedback for calibration.

In one embodiment, in example 1310 a received and recognized input (e.g., a momentary force, an applied force that is moved on a touchpoint, etc.) is applied on the drawer icon or symbol (e.g., a received tap or directional swipe). Optionally, an icon or symbol in the full-width toolbar may be used to invoke an option menu. In one embodiment, in example 1320 an option menu appears with: Edit My Streams, Edit My Interests, etc. In one example embodiment, as shown in example 1320 a user selectable “Edit My Interests” option menu is selected based on a received and recognized input. In one embodiment, in example 1330 a display appears including a list of interest (previously chosen by the user in the first use). In one embodiment, interests may be reordered, deleted and added to based on a received and recognized input. In one example embodiment, the user may reorder interests based on preference, swipe to delete an interest, tap the “+” symbol to add an interest, etc.

In one embodiment, in example 1340 a detailed view of an individual stream allows the user to customize that stream. In one embodiment, a user may choose which features/content they desire to see, and on which device (e.g., electronic device 120, wearable device 140, etc.). In one embodiment, features/content that cannot be turned off are displayed but are not actionable. In one example embodiment, the selector may be greyed out or other similar displays indicating the feature is locked.

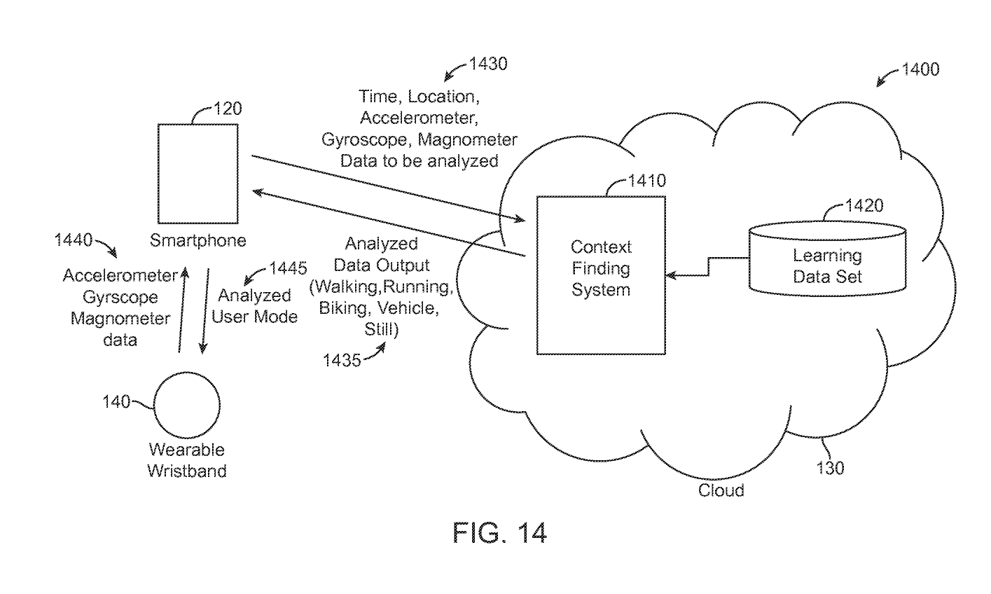

FIG. 14 shows an example overview for mode detection, according to one embodiment. In one embodiment, the overview shows an example user mode detection system 1400. In one embodiment, the system 1400 utilizes a wearable device 140 (e.g. a wristband paired with a host device, e.g., electronic device 120). In one embodiment, the wearable device 140 may provide onboard sensor data 1440, e.g., accelerometer, gyroscope, magnotometer, etc. to the electronic device 120. In one embodiment, the data may be provided over various communication interface methods, e.g., Bluetooth®, WiFi, NFC, cellular, etc. In one embodiment, the electronic device 120 may aggregate the wearable device 140 data with data from its own internal sensors, e.g., time, location (via GPS, cellular triangulation, beacons, or other similar methods), accelerometer, gyroscope, magnometer, etc. In one embodiment, this aggregated collection of data 1430 to be analyzed may be provided to a context finding system 1410 in cloud 150.

In one embodiment, the context finding system 1410 may be located in the cloud 150 or other network. In one embodiment, the context finding system 1410 may receive the data 1430 over various methods of communication interface. In one embodiment, the context finding system 1410 may comprise context determination engine algorithms to analyze the received data 1430 along with or after being trained with data from a learning data set 1420. In one example embodiment, an algorithm may be a machine learning algorithm, which may be customized to user feedback. In one embodiment, the learning data set 1420 may comprise initial general data for various modes compiled from a variety of sources. New data may be added to the learning data set in response to provided feedback for better mode determination. In one embodiment, the context finding system 1410 may then produce an output of the analyzed data 1435 indicating the mode of the user and provide it back to the electronic device 120.

In one embodiment, the smartphone may provide the mode 1445 back to the wearable device 140, utilize the determined mode 1445 in a LifeHub application (e.g., activity module 132, FIG. 2) or a life logging application (e.g., organization module 133), or even use it to throttle messages pushed to the wearable device 140 based on context. In one example embodiment, if the user is engaged in an activity, such as driving or biking, the electronic device 120 may receive that mode 1445 and prevent messages from being sent to the wearable device 140 or offer non-intrusive notification so the user will not be distracted. In one embodiment, this essentially takes into account the user's activity instead of relying on another method, e.g., geofencing. In one example embodiment, another example may include automatically activating a pedometer mode to show distance traveled if the user is detected running.

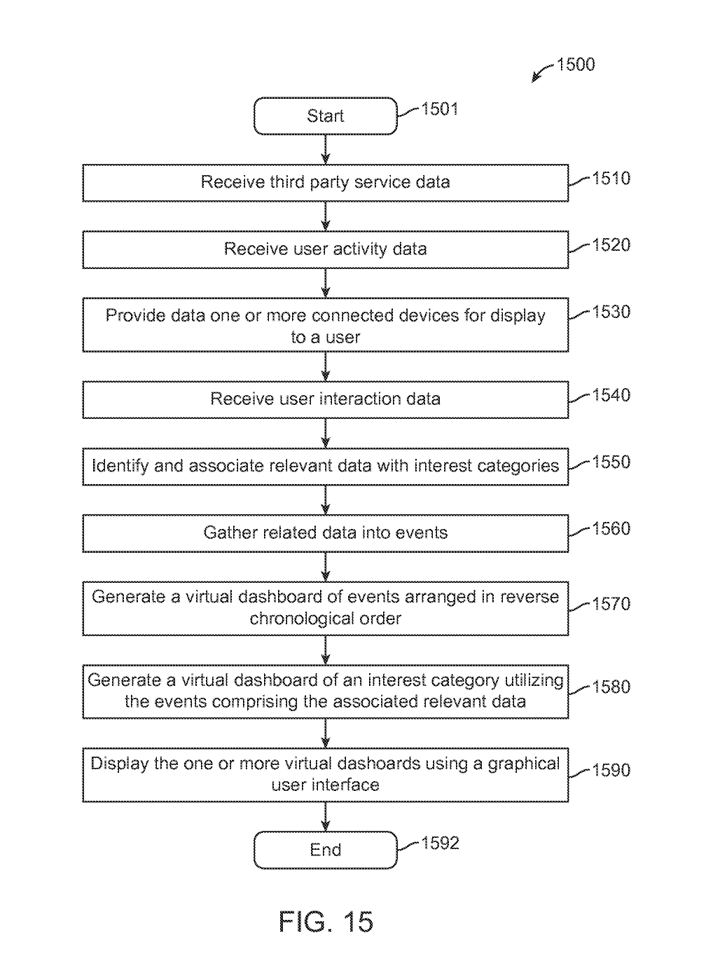

FIG. 15 shows an example process 1500 for aggregating/collecting and displaying user data, according to one embodiment. In one embodiment, in block 1501 the process 1500 begins (e.g., automatically, manually, etc.). In block 1510 an activity module 132 (FIG. 2) receives third-party service data (e.g., from electronic device 120, and/or wearable device 140). In block 1520 the activity module 132 receives user activity data (e.g., from electronic device 120, and/or wearable device 140). In block 1530 the collected data is provided to one or more connected devices (e.g., electronic device 120, and/or wearable device 140) for display to user. In block 1540 user interaction data is received by an activity module 132.

In block 1550 relevant data is identified and associated with interest categories (e.g., by the context finding system 1410 (FIG. 14). In block 1560 related data is gathered into events (e.g., by the context finding system 1410, or the organization module 133). In block 1570 a virtual dashboard of events is generated and arranged in reverse chronological order (e.g., by an organization module 133). In block 1580, a virtual dashboard of an interest category is generated utilizing the events comprising the associate relevant data. In one embodiment, in block 1590 the one or more virtual dashboards are displayed using the timeline 420 (FIG. 4) GUI. In block 1592 the process 1500 ends.

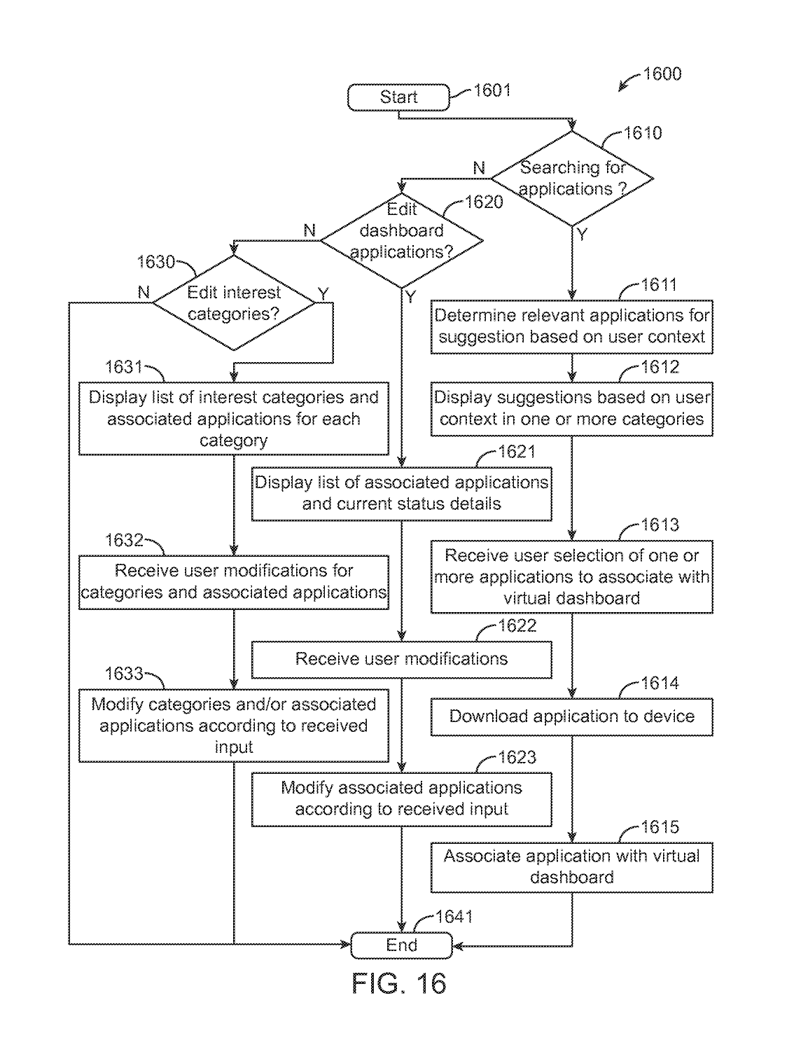

FIG. 16 shows an example process for service management through an electronic device, according to one embodiment. In one embodiment, process 1600 begins at the start block 1601. In block 1610 it is determined whether the process 1600 is searching for applications. If the process 1600 is searching for applications, process 1600 proceeds to block 1611 where relevant applications for suggestion based on user context are determined. If the process 1600 is not searching for applications, then process 1600 proceeds to block 1620 where it is determined whether to edit dashboard applications or not. If it is determined to dashboard applications are to be edited, process 1600 proceeds to block 1621 where a list of associated applications and current status details are displayed. If it is determined not to edit dashboard applications, then process 1600 proceeds to block 1630 where it is determined whether to edit interest categories or not. If it is determined to not edit the interest categories, process 1600 proceeds to block 1641.

After block 1611 process 1600 proceeds to block 1612 where suggestions based on user context in one or more categories are displayed. In block 1613 a user selection of one or more applications to associate with a virtual dashboard are received. In block 1614 one or more applications are downloaded to an electronic device (e.g., electronic device 120, FIG. 2). In block 1615 the downloaded application is associated with the virtual dashboard.

In block 1622 user modifications are received. In block 1623 associated applications are modified according to received input.

If it is determined to edit the interest categories, in block 1631 a list of interest categories and associated applications for each category is displayed. In block 1632 user modifications for categories and associated applications are received. In block 1633, categories and/or associated applications are modified according to the received input.

Process 1600 proceeds after block 1633, block 1623, or block 1615 and ends at block 1641.

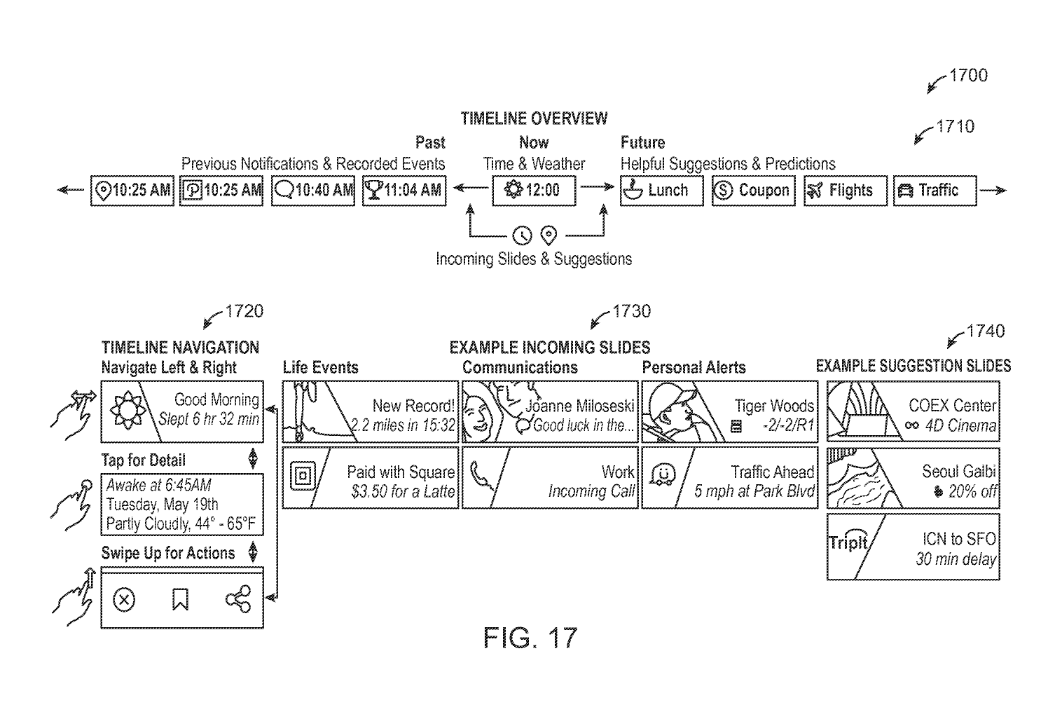

FIG. 17 shows an example 1700 of a timeline overview 1710 and slides/time-based elements 1730 and 1740, according to one embodiment. In one embodiment, the wearable device 140 (FIG. 2) may comprise a wristband type device. In one example embodiment, the wristband device may comprise straps forming a bangle-like structure. In one example embodiment, the bangle-like structure may be circular or oval shaped to conform to a user's wrist.

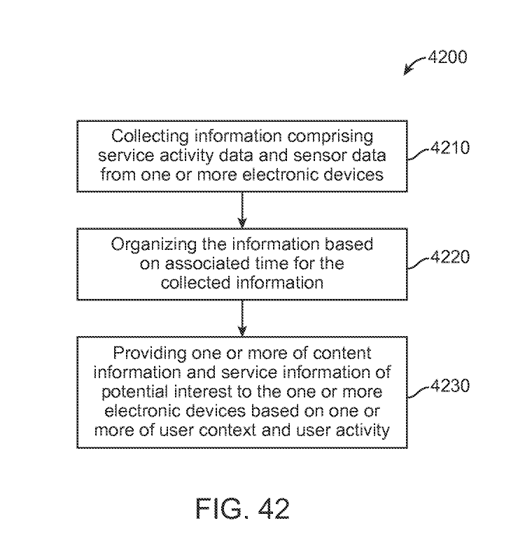

In one embodiment, the wearable device 140 may include a curved organic light emitting diode (OLED) touchscreen, or similar type of display screen. In one example embodiment, the OLED screen may be curved in a convex manner to conform to the curve of the bangle structure. In one embodiment, the wearable device 140 may further comprise a processor, memory, communication interface, a power source, etc. as described above. Optionally, the wearable device may comprise components described below in FIG. 42.

In one embodiment, the timeline overview 1710 includes data instances (shown through slides/data or content time-based elements) and is arranged in three general categories, Past, Now (present), and Future (suggestions). Past instances may comprise previous notifications or recorded events as seen on the left side of the timeline overview 1710. Now instances may comprise time, weather, or other incoming slides 1730 or suggestions 1740 presently relevant to a user. In one example, incoming slides (data or content time-based elements) 1730 may be current life events (e.g., fitness records, payment, etc.), incoming communications (e.g., SMS texts, telephone calls, etc.), personal alerts (e.g., sports scores, current traffic, police, emergency, etc.). Future instances may comprise relevant helpful suggestions and predictions. In one embodiment, predictions or suggestions may be based on a user profile or a user's previous actions/preferences. In one example, suggestion slides 1740 may comprise recommendations such as coupon offers near a planned location, upcoming activities around a location, airline delay notifications, etc.

In one embodiment, incoming slides 1730 may fall under push or pull notifications, which are described in more detail below. In one embodiment, timeline navigation 1720 is provided through a touch based interface (or voice commands, motion or movement recognition, etc.). Various user actuations or gestures may be received and interpreted as navigation commands. In one example embodiment, a horizontal gesture or swipe may be used to navigate left and right horizontally, a tap may display the date, an upward or vertical swipe may bring up an actions menu, etc.

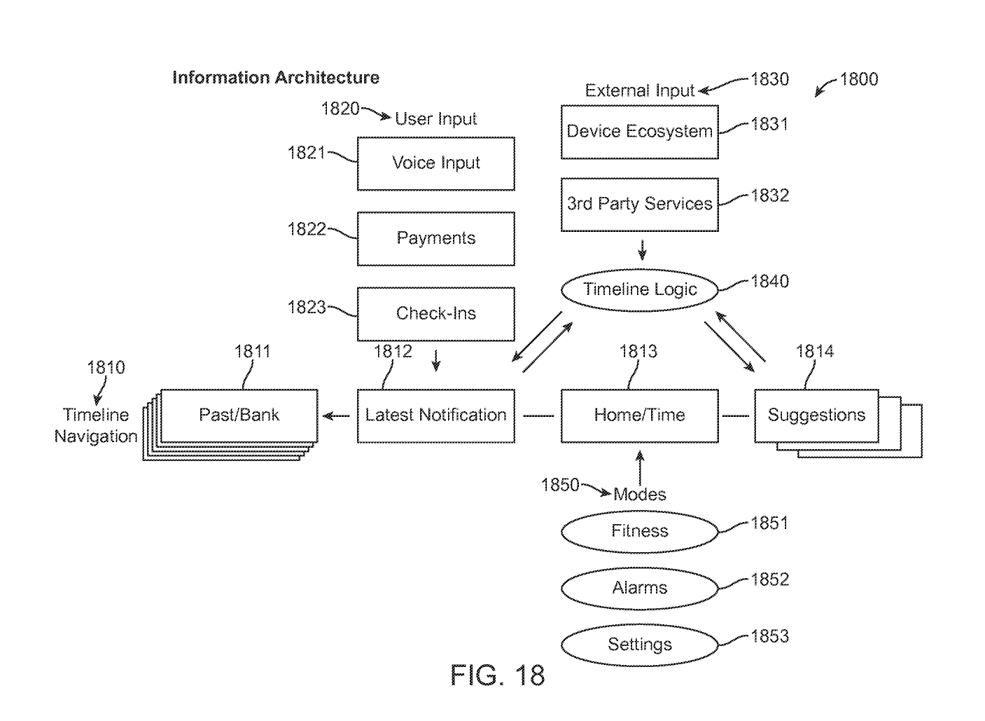

FIG. 18 shows an example information architecture 1800, according to one embodiment. In one embodiment, the example architecture 1800 shows an exemplary information architecture of the timeline user experience through timeline navigation 1810. In one embodiment, Past slides (data or content time-based elements) 1811 may be stored for a predetermined period or under other conditions in an accessible bank before being deleted. In one example embodiment, such conditions may include the size of the cache for storing past slides. In one embodiment, the Now slides comprise the latest notification(s) (slides, data or content time-based elements) 1812 and home/time 1813 along with active tasks.

In one embodiment, latest notifications 1812 may be received from User input 1820 (voice input 1821, payments 1822, check-ins 1823, touch gestures, etc.). In one embodiment, External input 1830 from a device ecosystem 1831 or third party services 1832 may be received though Timeline Logic 1840 provided from a host device. In one embodiment, latest notification 1812 may also send data in communication with Timeline Logic 1840 indicating user actions (e.g., dismissing or canceling a notification). In one embodiment, the latest notifications 1812 may last until the user views them and may then be moved to the past 1811 stack or removed from the wearable device 140 (FIG. 2).

In one embodiment, the timeline logic 1840 may insert new slides as they enter to the left of the most recent latest notification slide 1812, e.g., further away from home 1813 and to the right of any active tasks. Optionally, there may be exceptions where incoming slides are placed immediately to the right of the active tasks.

In one embodiment, home 1813 may be a default slide which may display the time (or other possibly user configurable information). In one embodiment, various modes 1850 may be accessed from the home 1813 slide such as Fitness 1851, Alarms 1852, Settings 1853, etc.

In one embodiment, suggestions 1814 (future) slides/time-based elements may interact with Timeline logic 1840 similar to latest notifications 1812, described above. In one embodiment, suggestions 1814 may be contextual and based on time, location, user interest, user schedule/calendar, etc.

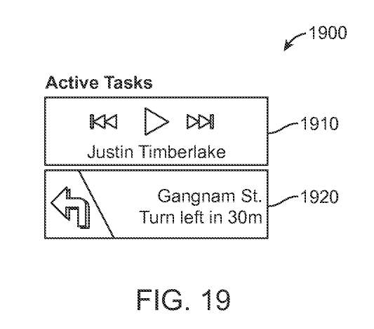

FIG. 19 shows example active tasks 1900, according to one embodiment. In one example embodiment, two active tasks are displayed: music remote 1910 and navigation 1920, which each has a separate set of rules. In one embodiment, the active tasks 1900 do not recede into the timeline (e.g., timeline 420, FIG. 4) as other categories of slides. In one embodiment, the active slides 1900 stay readily available and may be displayed in lieu of home 1813 until the task is completed or dismissed.

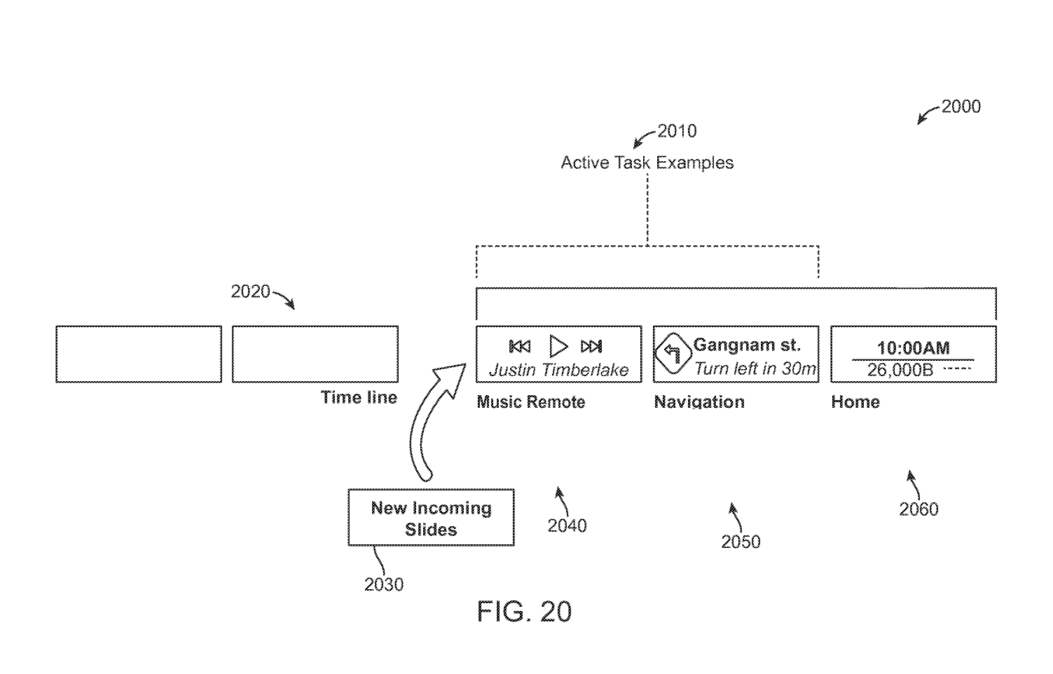

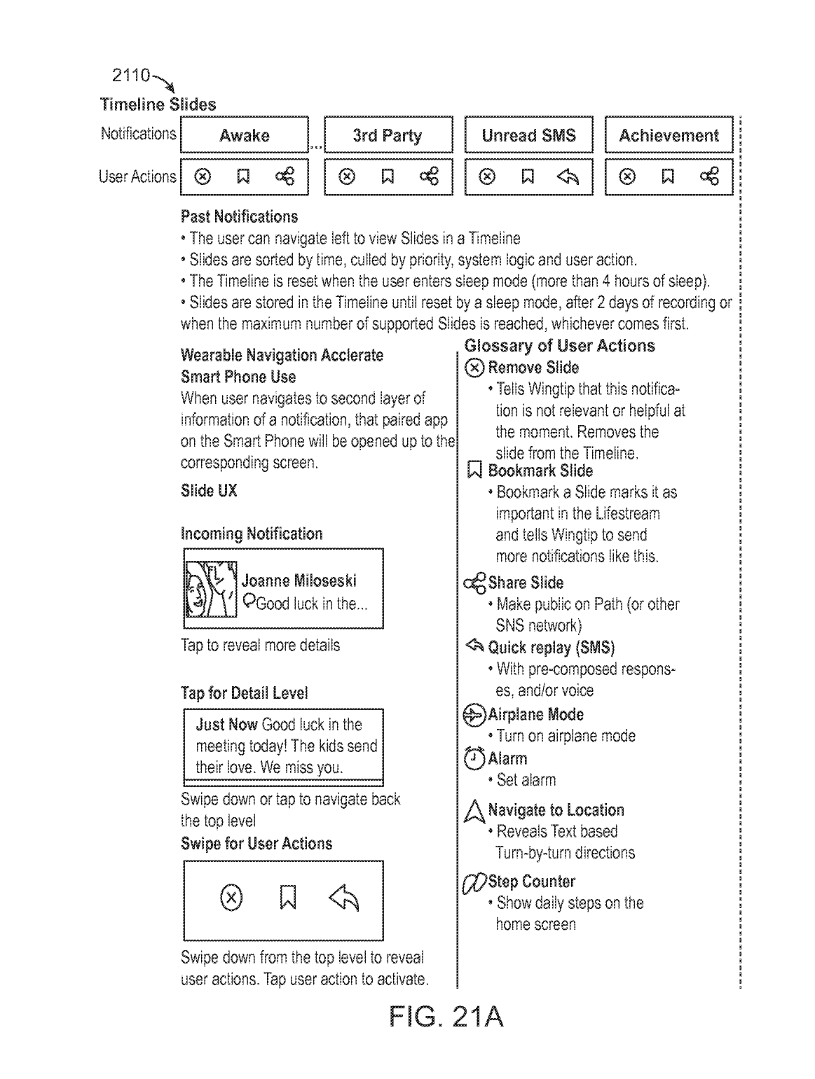

FIG. 20 shows an example 2000 of timeline logic with incoming slides 2030 and active tasks 2010, according to one embodiment. In one embodiment, new slides/time-based elements 2030 enter to the left of the active task slides 2010, and recede into the timeline 2020 as past slides when replaced by new content. In one embodiment, music remote 2040 active task slide is active when headphones are connected. In one embodiment, navigation 2050 slides are active when the user has requested turn-by-turn navigation. In one embodiment, the home slide 2060 may be a permanent fixture in the timeline 2020. In one embodiment, the home slide 2060 may be temporarily supplanted as the visible slide by an active task as described above.

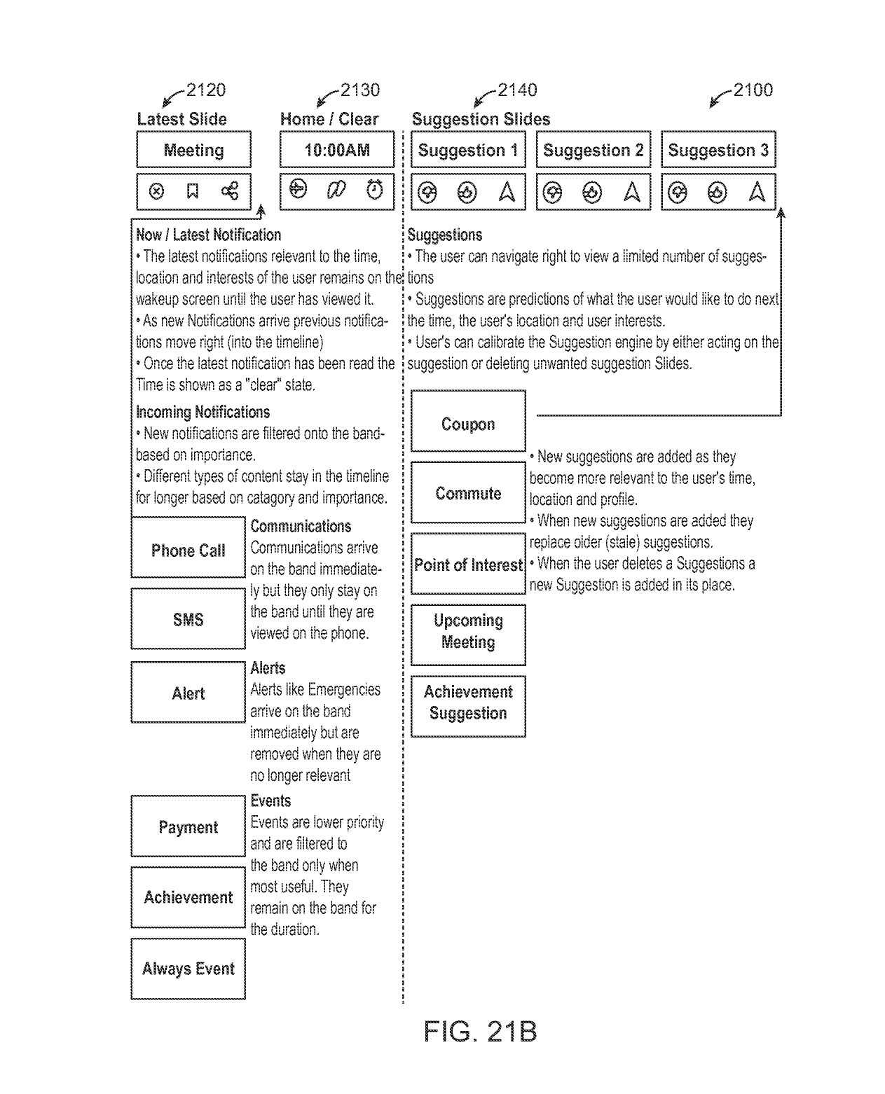

FIGS. 21A and 21B show an example detailed timeline 2110, according to one embodiment. In one embodiment, a more detailed explanation of implementing past notifications, now/latest notifications, incoming notifications, and suggestions is described. In one embodiment, the timeline 2110 shows example touch or gesture based user experience in interacting with slides/time-based elements. In one embodiment, the user experience timeline 2110 may include a feature where wearable device 140 (FIG. 2) navigation accelerates the host device (e.g., electronic device 120) use. In one embodiment, if a user navigates to a second layer of information (e.g., expands an event or slide/time-based element) from a notification, the application on the paired host device may be opened to a corresponding screen for more complex user input.

An exemplary glossary of user actions (e.g., symbols, icons, etc.) is shown in the second column from the left of FIG. 21A. In one embodiment, such user actions facilitate the limited input interaction of the wearable device 140. In one embodiment, the latest slide 2120, the home slide 2130 and suggestion slides 2140 are displayed on the timeline 2100.

In one embodiment, the timeline user experience may include a suggestion engine, which learns a user's preferences. In one embodiment, the suggestion engine may initially be trained through initial categories selected by the user and then self-calibrate based on feedback from a user acting on the suggestion or deleting a provided suggestion. In one embodiment, the engine may also provide new suggestions to replace stale suggestions or when a user deletes a suggestion.

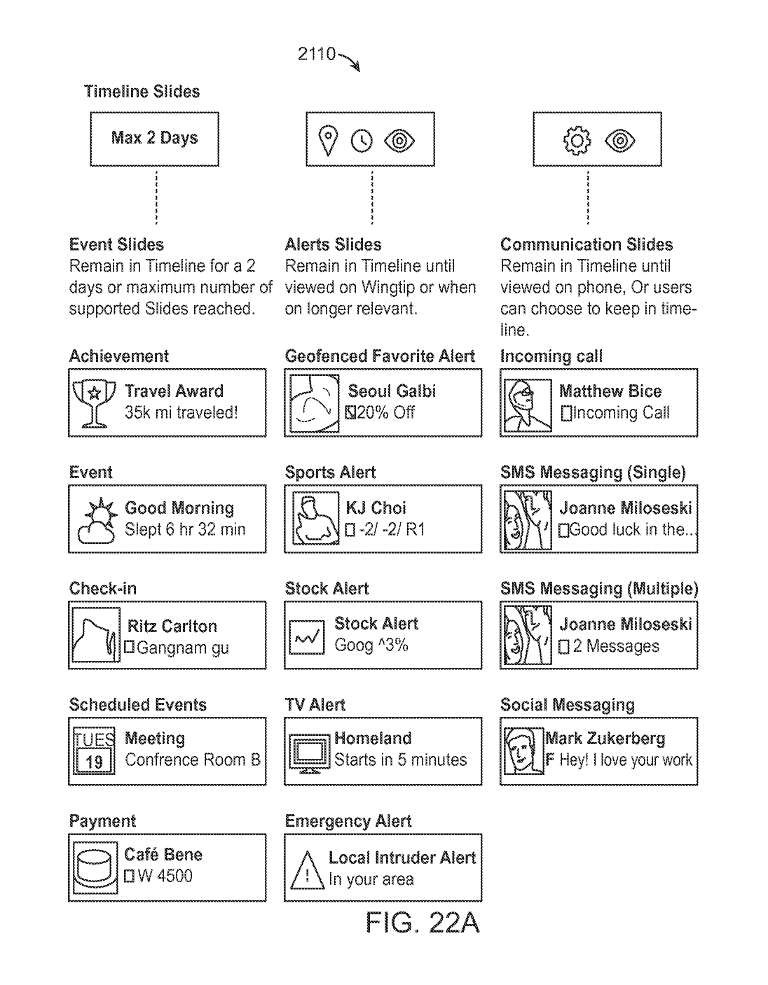

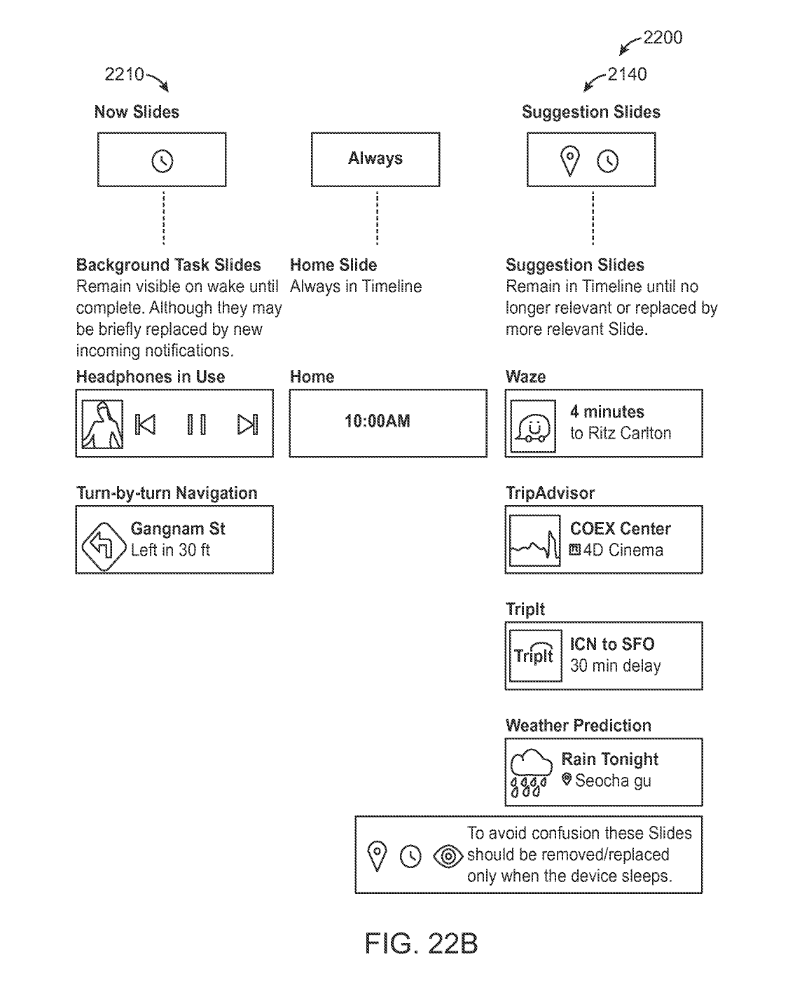

FIGS. 22A and 22B show example slide/time-based element categories 2200 for timeline logic, according to one embodiment. In one embodiment, the exemplary categories also indicate how long the slide (or card) may be stored on the wearable device 140 (FIG. 2) once an event is passed. In one embodiment, the timeline slides 2110 show event slides, alert slides, communication slides, Now slides 2210, Always slides (e.g., home slide) and suggestion slides 2140.

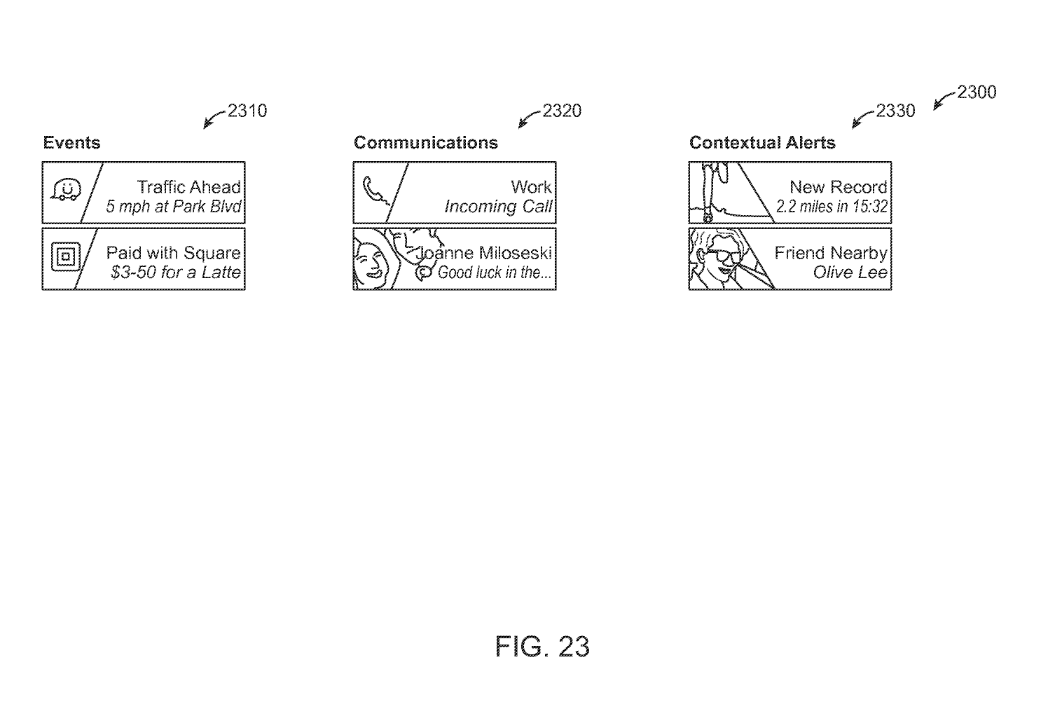

FIG. 23 shows examples of timeline push notification slide categories 2300, according to one embodiment. In one embodiment, events 2310, communications 2320 and contextual alerts 2330 categories are designated by the Timeline Logic as push notifications. In one example, the slide durations for events 2310 are either a predetermined number of days (e.g., two days), the selected maximum number of slides is reached or user dismissal, whichever is first. In one example embodiment, for communications 2320, the duration for slides is: they remain in the timeline until they are responded to, viewed on the electronic device 120 (FIG. 2) or dismissed; or remain in the timeline for a predetermined number of days (e.g., two days) or the maximum number of supported slides is reached. In one example embodiment, for contextual alerts 2330, the duration for slides is: they remain in the timeline until no longer relevant (e.g., when the user is no longer in the same location, or when the conditions or time has changed).

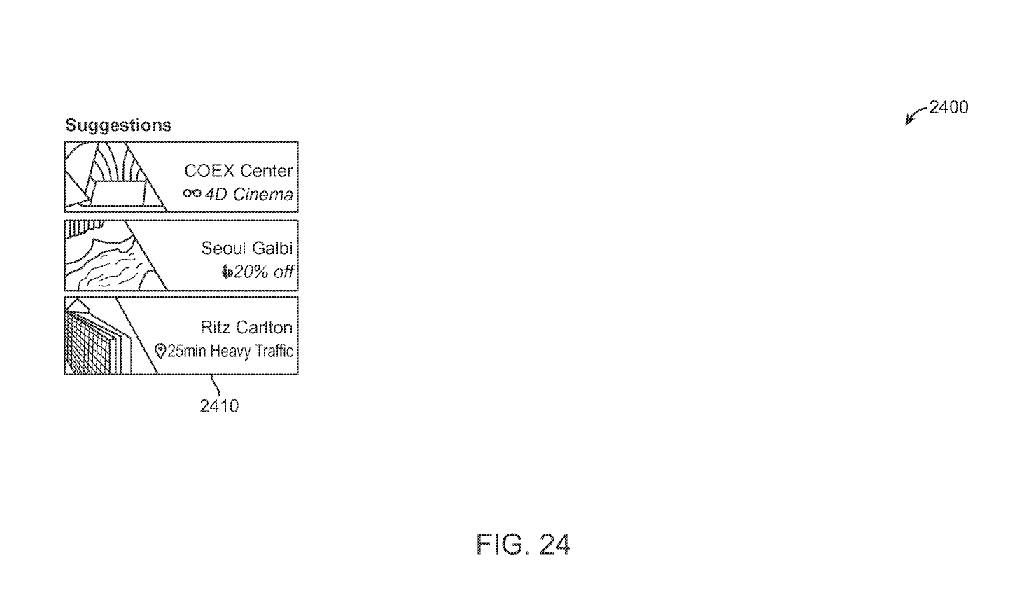

FIG. 24 shows examples of timeline pull notifications 2400, according to one embodiment. In one embodiment, suggestion slides 2410 are considered to be pull notifications and provided on a user request through swiping (e.g., swiping left) of the Home screen. In one embodiment, the user does not have to explicitly subscribe to a service to receive a suggestion 2410 from it. Suggestions may be based on time, location and user interest. In one embodiment, initial user interest categories may be defined in the wearable devices Settings app which may be located on the electronic device 120 or on the wearable device 140 (in future phases, use interest may be calibrated automatically by use). In one embodiment, examples of suggestions 2410 include: location-based coupons; popular recommendations for food; places; entertainment and events; suggested fitness or lifestyle goals; transit updates during non-commute times; events that happened later, such as projected weather or scheduled events, etc.

In one embodiment, a predetermined number of suggestions (e.g., three as shown in the example) may be pre-loaded when the user indicates they would like to receive suggestions (e.g., swipes left). In one example, additional suggestions 2410 (when available) may be loaded on the fly if the user continues to swipe left. In one embodiment, suggestions 2410 are refreshed when the user changes location or at specific times of the day. In one example, a coffee shop may be suggested in the morning, while a movie maybe suggested in late afternoon.

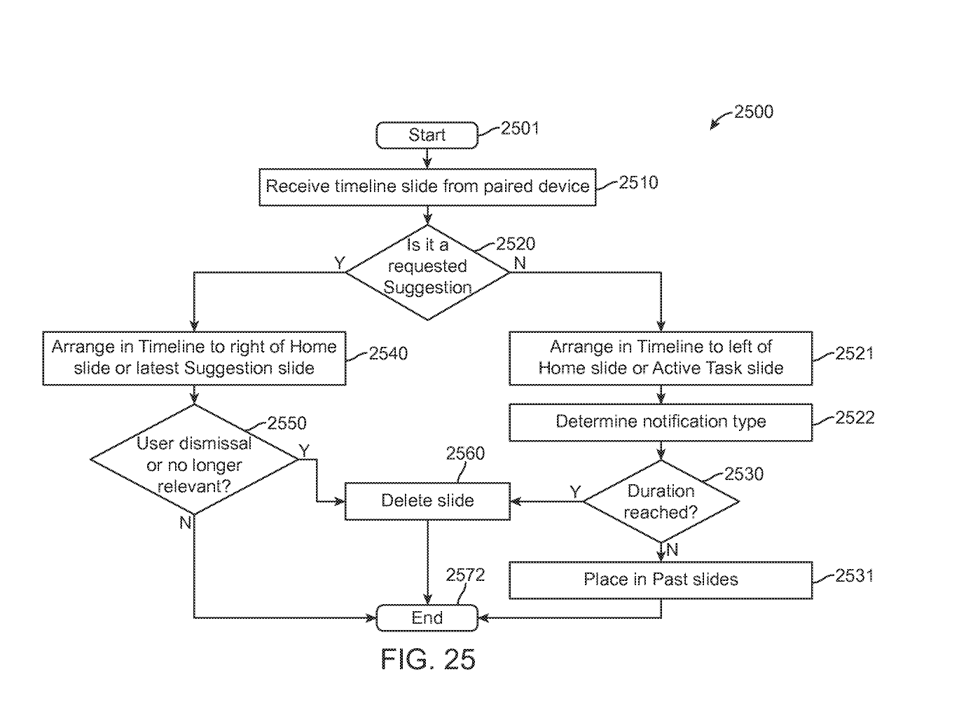

FIG. 25 shows an example process 2500 for routing an incoming slide, according to one embodiment. In one embodiment, process 2500 begins at the start block 2501. In block 2510 the timeline slide from a paired device (e.g., electronic device 120, FIG. 2) is received. In block 2520 the timeline logic determines whether the received timeline slide is a requested suggestion. If the received timeline slide is a requested suggestion, process 2500 proceeds to block 2540. In block 2540 the suggestion slide is arranged in the timeline to the right of the home slide or the latest suggestion slide.

In block 2550 is determined whether a user dismissal has occurred or the slide is no longer relevant. If the user has not dismissed the slide or the slide is still relevant, process 2500 proceeds to block 2572. If the user dismisses the slide or the slide is no longer relevant, process 2500 proceeds to block 2560 where the slide is deleted. Process 2500 then proceeds to block 2572 and the process ends. In block 2521 the slide is arranged in the timeline to the left of the home slide or the active slide. In block 2522 it is determined whether the slide is a notification type of slide. In block 2530 it is determined whether the duration for the slide has been reached. If the duration has been reached, process 2500 proceeds to block 2560 where the slide is deleted. If the duration has not been reached then process 2500 proceeds to block 2531 where the slide is placed in the past slides bank. Process 2500 then proceeds to block 2572 and ends.

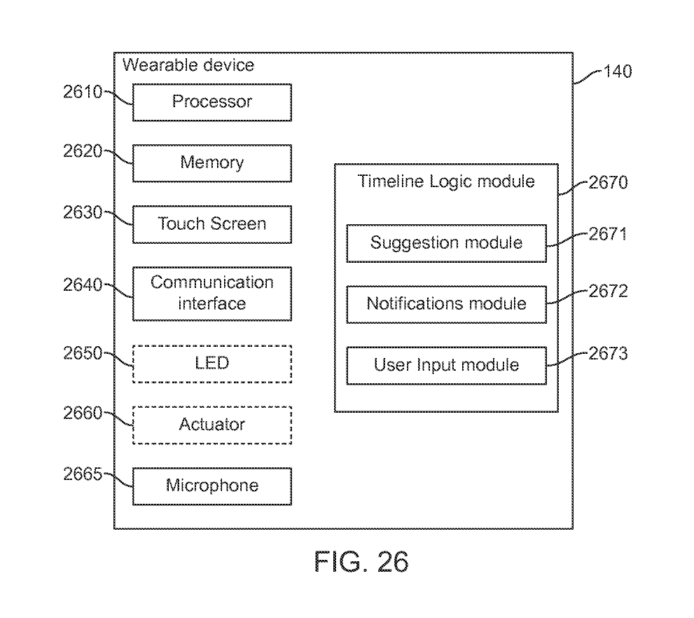

FIG. 26 shows an example wearable device 140 block diagram, according to one embodiment. In one embodiment, the wearable device 140 includes a processor 2610, a memory 2620, a touch screen 2630, a communication interface 2640, a microphone 2665, a timeline logic module 2670 and optional LED (or OLED, etc.) module 2650 and an actuator module 2660. In one embodiment, the timeline logic module includes a suggestion module 2671, a notifications module 2672 and user input module 2673.

In one embodiment, the modules in the wearable device 140 may be instructions stored in memory and executable by the processor 2610. In one embodiment, the communication interface 2640 may be configured to connect to a host device (e.g., electronic device 120) through a variety of communication methods, such as BlueTooth® LE, WiFi, etc. In one embodiment, the optional LED module 2650 may be a single color or multi-colored, and the actuator module 2660 may include one or more actuators. Optionally, the wearable device 140 may be configured to use the optional LED module 2650 and actuator module 2660 may be used for conveying unobtrusive notifications through specific preprogrammed displays or vibrations, respectively.

In one embodiment, the timeline logic module 2670 may control the overall logic and architecture of how the timeline slides are organized in the past, now, and suggestions. The timeline logic module 2670 may accomplish this by controlling the rules of how long slides are available for user interaction through the slide categories. In one embodiment, the timeline logic module 2670 may or may not include sub-modules, such as the suggestion module 2671, notification module 2672, or user input module 2673.

In one embodiment, the suggestion module 2671 may provide suggestions based on context, such as user preference, location, etc. Optionally, the suggestion module 2671 may include a suggestion engine, which calibrates and learns a user's preferences through the user's interaction with the suggested slides. In one embodiment, the suggestion module 2671 may remove suggestion slides that are old or no longer relevant, and replace them with new and more relevant suggestions.

In one embodiment, the notifications module 2672 may control the throttling and display of notifications. In one embodiment, the notifications module 2672 may have general rules for all notifications as described below. In one embodiment, the notifications module 2672 may also distinguish between two types of notifications, important and unimportant. In one example embodiment, important notifications may be immediately shown on the display and may be accompanied by a vibration from the actuator module 2660 and/or the LED module 2650 activating. In one embodiment, the screen may remain off based on a user preference and the important notification may be conveyed through vibration and LED activation. In one embodiment, unimportant notifications may merely activate the LED module 2650. In one embodiment, other combinations may be used to convey and distinguish between important or unimportant notifications. In one embodiment, the wearable device 140 further includes any other modules as described with reference to the wearable device 140 shown in FIG. 2.

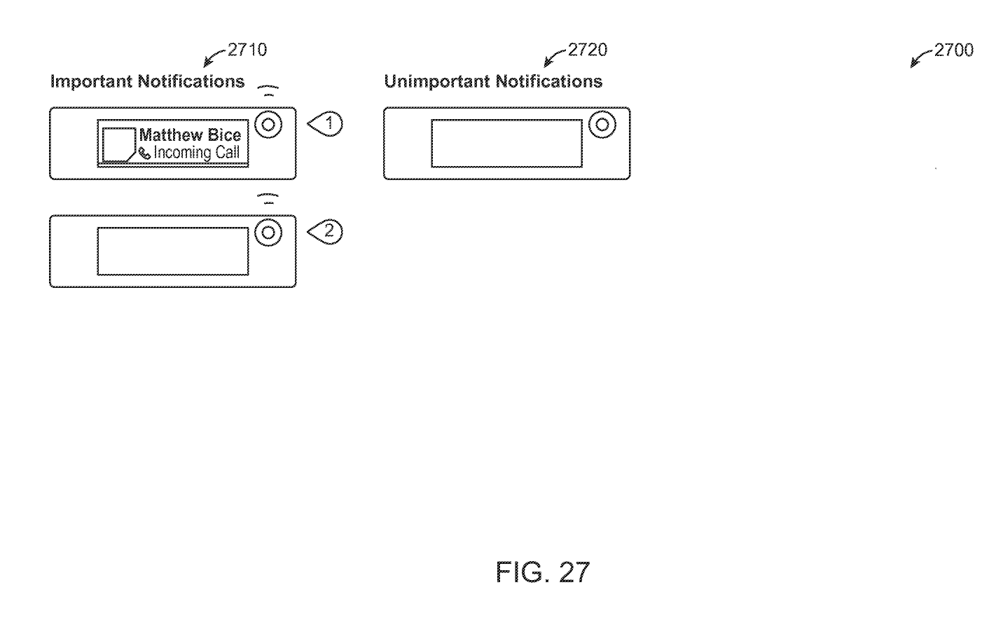

FIG. 27 shows example notification functions 2700, according to one embodiment. In one embodiment, the notifications include important notifications 2710 and unimportant notifications 2720. The user input module 2673 may recognize user gestures on the touch screen 2630, sensed user motions, or physical buttons in interacting with the slides. In one example embodiment, when the user activates the touch screen 2630 following a new notification, that notification is visible on the touch screen 2630. In one embodiment, the LED from the LED module 2650 is then turned off, signifying “read” status. In one embodiment, if content is being viewed on the wearable device 140 when a notification arrives, the touch screen 2630 will remain unchanged (to avoid disruption), but the user will be alerted with an LED alert from the LED module 2650 and if the message is important, with a vibration as well from the actuator module 2660. In one embodiment, the wearable device 140 touch screen 2630 will turn off after a particular number of seconds of idle time (e.g., 15 seconds, etc.), or after another time period (e.g., 5 seconds) if the user's arm is lowered.

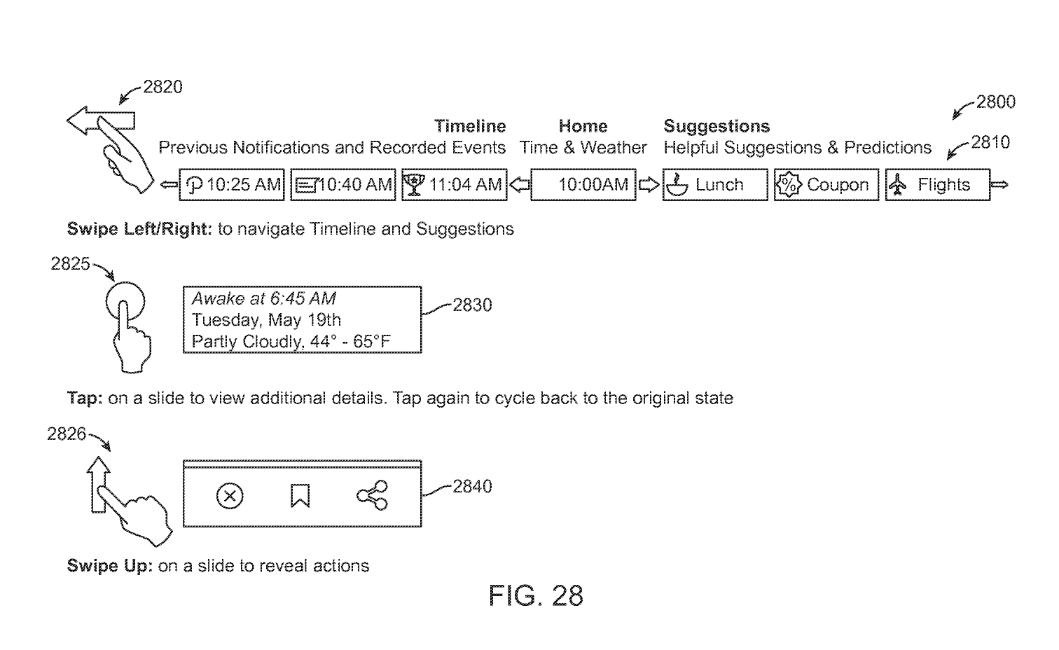

FIG. 28 shows example input gestures 2800 for interacting with a timeline architecture, according to one embodiment. In one embodiment, the user may swipe 2820 left or right on the timeline 2810 to navigate the timeline and suggestions. In one embodiment, a tap gesture 2825 on a slide shows additional details 2830. In one embodiment, another tap 2825 cycles back to the original state. In one embodiment, a swipe up 2826 on a slide reveals actions 2840.

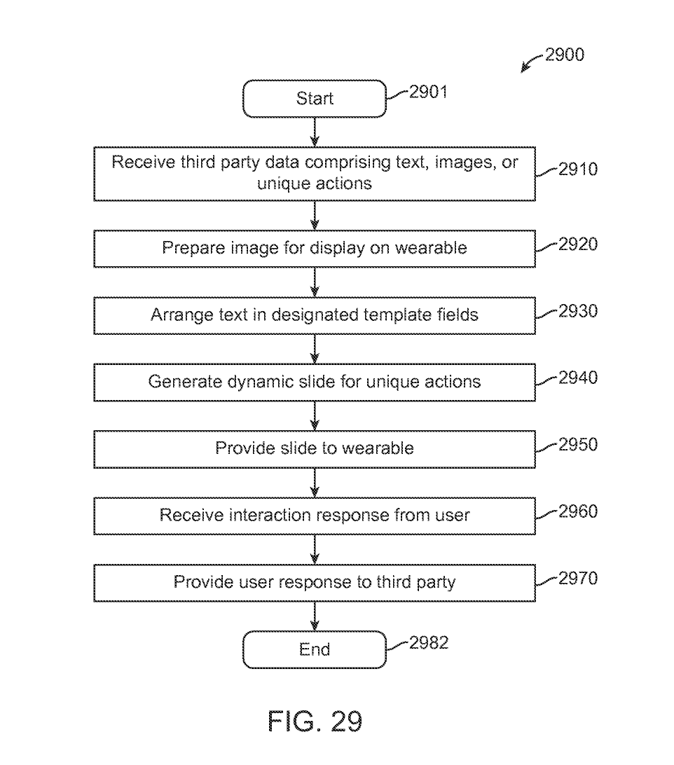

FIG. 29 shows an example process 2900 for creating slides, according to one embodiment. In one embodiment, process 2900 begins at the start block 2901. In block 2910 third-party data comprising text, images, or unique actions are received. In block 2920 the image is prepared for display on the wearable device (e.g., wearable device 140, FIG. 2, FIG. 26). In block 2930 text is arranged in designated template fields. In block 2940, a dynamic slide is generated for unique actions. In block 2950, the slide is provided to the wearable device. In block 2960, an interaction response is received from the user. In block 2970, the user response is provided to the third party. Process 2900 proceeds to the end block 2982.

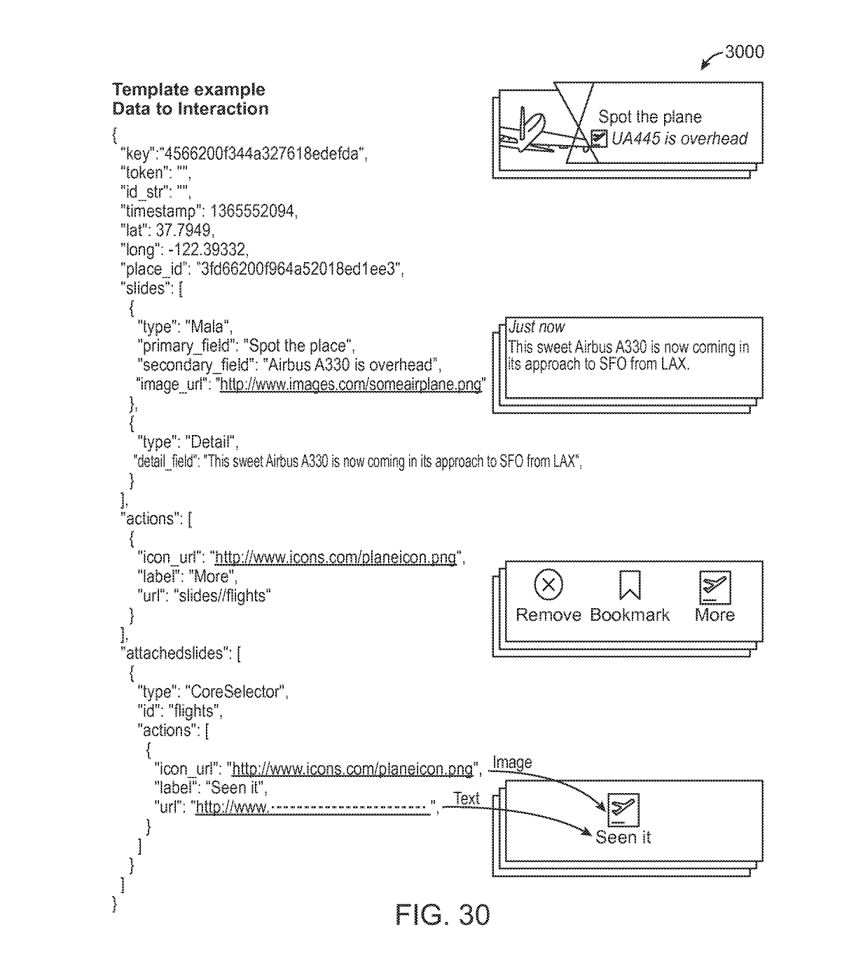

FIG. 30 shows an example of slide generation 3000 using a template, according to one embodiment. In one embodiment, the timeline slides provide a data to interaction model. In one embodiment, the model allows for third party services to interact with users without expending extensive resources in creating slides. The third party services may provide data as part of the external input 1830 (FIG. 18). In one embodiment, the third party data may comprise text, images, image pointers (e.g., URLs), or unique actions. In one example embodiment, such third party data may be provided through the third party application, through an API, or through other similar means, such as HTTP. In one embodiment, the third party data may be transformed into a slide, card, or other appropriate presentation format for a specific device (e.g., based on screen size or device type), either by the wearable device 140 (FIG. 2, FIG. 26) logic, the host device (e.g., electronic device 120), or even in the cloud 150 (FIG. 2) for display on the wearable device 140 through the use of a template.

In one embodiment, the data to interaction model may detect the target device and determine a presentation format for display (e.g., slides/cards, the appropriate dimensions, etc.) In one embodiment, the image may be prepared through feature detection and cropping using preset design rules tailored to the display. For example, the design rules may indicate the portion of the picture that should be the subject (e.g., plane, person's face, etc.) that relates to the focus of the display.

In one embodiment, the template may comprise designated locations (e.g., preset image, text fields, designs, etc.). As such, the image may be inserted into the background and the appropriate text provided into various fields (e.g., the primary or secondary fields). The third party data may also include data which can be incorporated in additional levels. The additional levels may be prepared through the use of detail or action slides. Some actions may be default actions which can be included on all slides (e.g., remove, bookmark, etc.). In one embodiment, unique actions provided by the third party service may be placed on a dynamic slide generated by the template. The unique actions may be specific to slides generated by the third party. For example, the unique action shown in the exemplary slide in FIG. 30 may be the indication the user has seen the airplane. The dynamic slide may be accessible from the default action slide.

In one embodiment, the prepared slide may be provided to the wearable device 140 where the timeline logic module 2670 (FIG. 26) dictates its display. In one embodiment, user response may be received from the interaction. The results may be provided back to the third party through similar methods as the third party data was initially provided, e.g., third party application, through an API, or through other means, such as HTTP.

FIG. 31 shows examples 3100 of contextual voice commands based on a displayed slide, according to one embodiment. In one embodiment, the wearable device 140 uses a gesture 3110 including, for example, a long press from any slide 3120 to receive a voice prompt 3130. Such a press may be a long touch detected on a touchscreen or holding down a physical button. In one embodiment, general voice commands 3140 and slide-specific voice commands 3150 are interpreted for actions. In one embodiment, a combination of voice commands and gesture interaction on the wearable device 140 (e.g., wristband) is used for navigation of an event-based architecture. In one example embodiment, such a melding of voice commands and gesture input may include registering specific gestures through internal sensors (e.g., an accelerometer, gyroscope, etc.) to trigger a voice prompt 3130 for user input.

In one embodiment, the combined voice and gesture interaction with visual prompts provides a dialogue interaction to improve user experience. In addition, the limited gesture/touch based input is greatly supplemented with voice commands to assist actions in the event based system, such as searching for a specific slide/card, quick filtering and sorting, etc. In one embodiment, the diagram describes an example of contextual voice commands based on the slide displayed on the touchscreen (e.g., slide specific voice commands 3150) or general voice commands 3140 from any display.

In one example embodiment, when any slide is displayed a user may execute a long press 3120 actuation of a hard button to activate the voice command function. In other embodiments, the voice command function may be triggered through touch gestures or recognized user motions via embedded sensors. In one example embodiment, the wearable device 140 may be configured to trigger voice input if the user flips their wrist while raising the wristband to speak into it or the user performs a short sequence of sharp wrist shakes/motions.

In one embodiment, the wearable device 140 displays a visual prompt on the screen informing a user it is ready to accept verbal commands. In another example embodiment, the wearable device 140 may include a speaker to provide an audio prompt or if the wearable is placed in a base station or docking station, the base station may comprise speakers for providing audio prompts. In one embodiment, the wearable device 140 provides a haptic notification (such as a specific vibration sequence) to notify the user it is in listening mode.

In one embodiment, the user dictates a verbal command from a preset list recognizable by the device. In one embodiment, example general voice commands 3140 are shown in the example 3100. In one embodiment, the commands may be general (thus usable from any slide) or contextual and apply to the specific slide displayed. In one embodiment, in specific situations, a general command 3140 may be contextually related to the presently displayed slide. In one example embodiment, if a location slide is displayed, the command “check-in” may check in at the location. Additionally, if a slide includes a large list of content, a command may be used to select specific content on the slide.

In one embodiment, the wearable device 140 may provide system responses requesting clarification or more information and await the user's response. In one example embodiment, this may be from the wearable device 140 not understanding the user's command, recognizing the command as invalid/not in the preset commands, or the command requires further user input. In one embodiment, once the entire command is ready for execution the wearable device 140 may have the user confirm and then perform the action. In one embodiment, the wearable device 140 may request confirmation then prepare the command for execution.

In one embodiment, the user may also interact with the wearable device 140 through actuating the touchscreen either simultaneously or concurrently with voice commands. In one example embodiment, the user may use finger swipes to scroll up or down to review commands. Other gestures may be used clear commands (e.g., tapping the screen to reveal the virtual clear button), or touching/tapping a virtual confirm button to accept commands. In other embodiments, physical buttons may be used. In one example embodiment, the user may dismiss/clear voice commands and other actions by pressing a physical button or switch (e.g., the Home button).

In one embodiment, the wearable device 140 onboard sensors (e.g., gyroscope, accelerometer, etc.) are used to register motion gestures in addition to finger gestures on the touchscreen. In one example embodiment, using registered motions or gestures may be used to cancel or clear commands (e.g., shaking the wearable device 140 once). In other example embodiments, navigation by tilting the wrist to scroll, rotating the wrist in a clockwise motion to move to the next slide or counterclockwise to move to a previous slide may be employed. In one embodiment, there may be contextual motion gestures that are recognized by certain categories of slides.

In one embodiment, the wearable device 140 may employ appless processing, where the primary display for information comprises cards or slides as opposed to applications. One or more embodiments may allow users to navigate the event based system architecture without requiring the user to parse through each slide. In one example embodiment, the user may request a specific slide (e.g., “Show 6:00 this morning”) and the slide may be displayed on the screen. Such commands may also pull back archived slides that are no longer stored on the wearable device 140. In one embodiment, some commands may present choices which may be presented on the display and navigated via a sliding-selection mechanism. In one example embodiment, a voice command to “Check-in” may result in a display of various venues allowing or requesting the user to select one for check-in.

In one embodiment, an interesting display of card-based navigation through quick filtering and sorting, allowing ease of access to pertinent events may be used. In one example embodiment, the command “What was I doing yesterday at 3:00 PM?” may provide a display of the subset of available cards around the time indicated. In one embodiment, the wearable device 140 may display a visual notification indicating the number of slides comprising the subset or criteria. If the number comprising the subset is above a predetermined threshold (e.g., 10 or more cards), the wristband may prompt the user whether they would like to perform further filtering or sorting. In one embodiment, a user may use touch input to navigate the subset of cards or utilize voice commands to further filter or sort the subset (e.g., “Arrange in order of relevance,” “Show achievements first,” etc.).

In one embodiment, another embodiment may include voice commands which perform actions in third party services on the paired device (e.g., electronic device 120, FIG. 2). In one example embodiment, the user may check in at a location which may be reflected through third party applications, such as Yelp®, Facebook®, etc. without opening the third party service on the paired device. Another example embodiment comprises a social update command, allowing the user to update status on a social network, e.g., a Twitter® update shown above, a Facebook® status update, etc.

In one embodiment, the voice commands (e.g., general voice commands 3140 and slide specific voice commands 3150) may be processed by the host device that the wearable device 140 is paired to. In one embodiment, the commands will be passed to the host device. Optionally, the host device may provide the commands to the cloud 150 (FIG. 2) for assistance in interpreting the commands. In one embodiment, some commands may remain exclusive to the wearable device 140. For example, “go to” commands, general actions, etc.

In one embodiment, while the wearable device 140 interacts with outside devices or servers primarily through the host device, in some embodiments, the wearable device 140 may have a direct communication connection to other devices in a user's device ecosystem, such as television, tablets, headphones, etc. In one embodiment, other examples of devices may include a thermostat (e.g., Nest), scale, camera, or other connected devices in a network. In one embodiment, such control may include activating or controlling the devices or help enable the various devices to communicate with each other.

In one embodiment, the wearable device 140 may recognize a pre-determined motion gesture to trigger a specific condition of listening, i.e., a filtered search for a specific category or type of slides. For example, the device may recognize the sign language motion for “suggest” and may limit the search to the suggestion category cards. In one embodiment, the wearable device 140 based voice command may utilize the microphone for sleep tracking. Such monitoring may also utilize various other sensors comprising the wearable device 140 including the accelerometer, gyroscope, photo detector, etc. The data pertaining to the light, sound, and motion may provide for more accurate determinations, on analysis, of determining when a user went to sleep and awoke, along with other details of the sleep pattern.

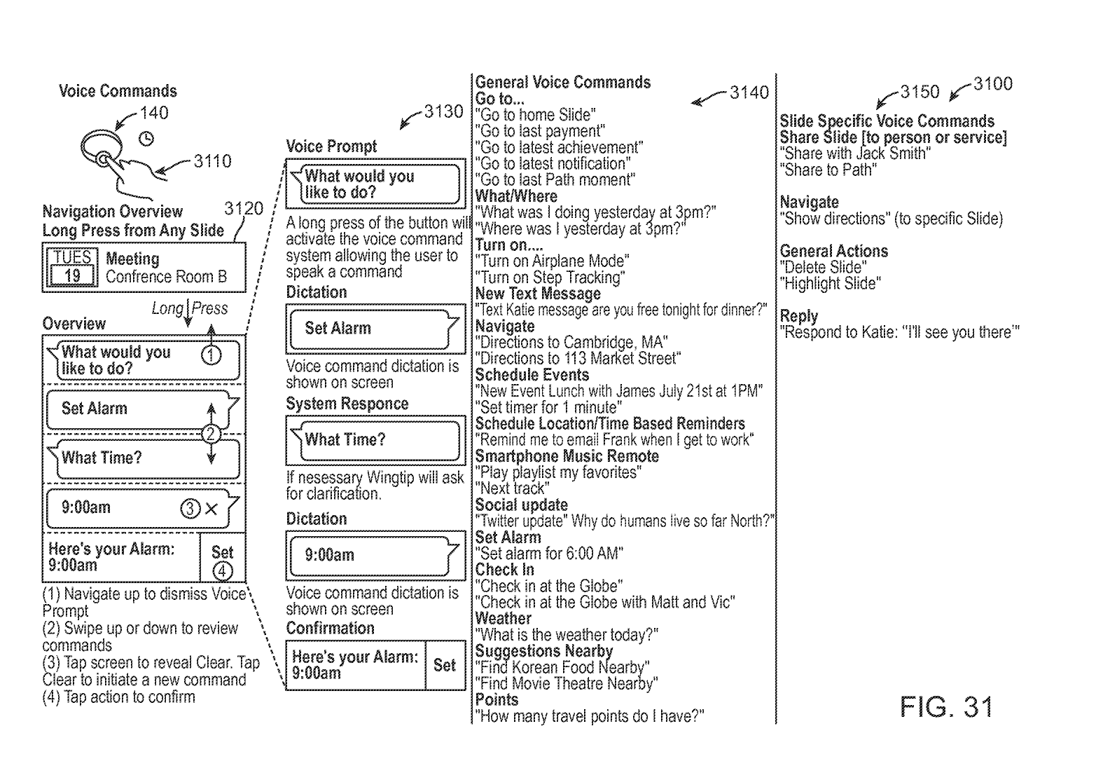

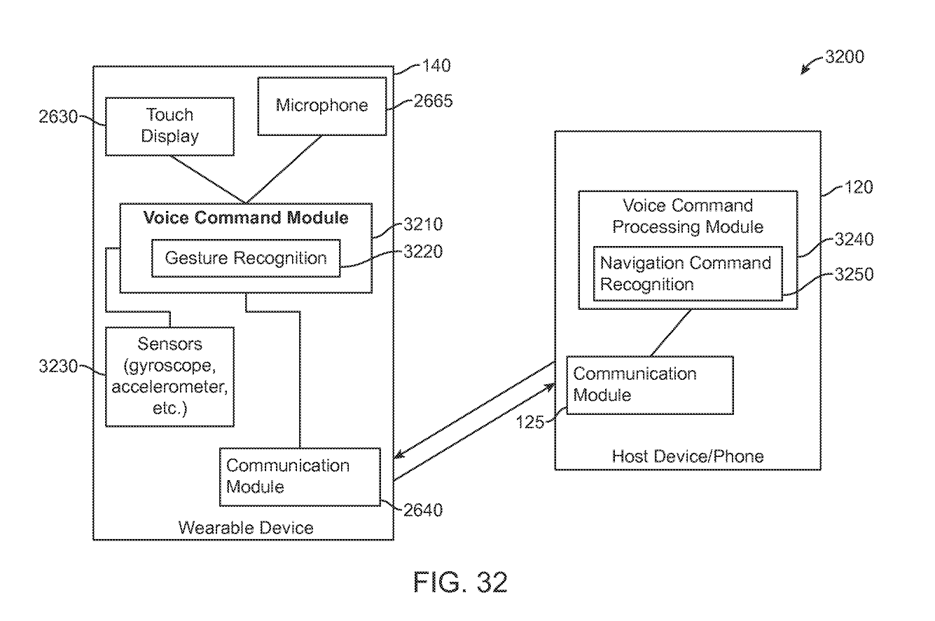

FIG. 32 shows an example block diagram 3200 for a wearable device 140 and host device (e.g., electronic device 120), according to one embodiment. In one embodiment, the voice command module 3210 onboard the wearable device 140 may be configured to receive input from the touch display 2630, microphone 2665, sensor 3230, and communication module 2640 components, and provide output to the touch display 2630 for prompts/confirmation or to the communication module 2640 for relaying commands to the host device (e.g., electronic device 120) as described above. In one embodiment, the voice command module 3210 may include a gesture recognition module 3220 to process touch or motion input from the touch display 2630 or sensors 3230, respectively.

In one embodiment, the voice command processing module 3240 onboard the host device (e.g., electronic device 120) may process the commands for execution and provide instructions to the voice command module 3210 on the wearable device 140 through the communication modules (e.g., communication module 2640 and 125). In one embodiment, such voice command processing module 3240 may comprise a companion application programmed to work with the wearable device 140 or a background program that may be transparent to a user.

In one embodiment, the voice command processing module 3240 on the host device (e.g., electronic device 120) may merely process the audio or voice data transmitted from the wearable device 140 and provide the processed data in the form of command instructions for the voice command module 3210 on the wearable device 140 to execute. In one embodiment, the voice command processing module 3240 may include a navigation command recognition sub-module 3250, which may perform various functions such as identifying cards no longer available on the wearable device 140 and providing them to the wearable device 140 along with the processed command.

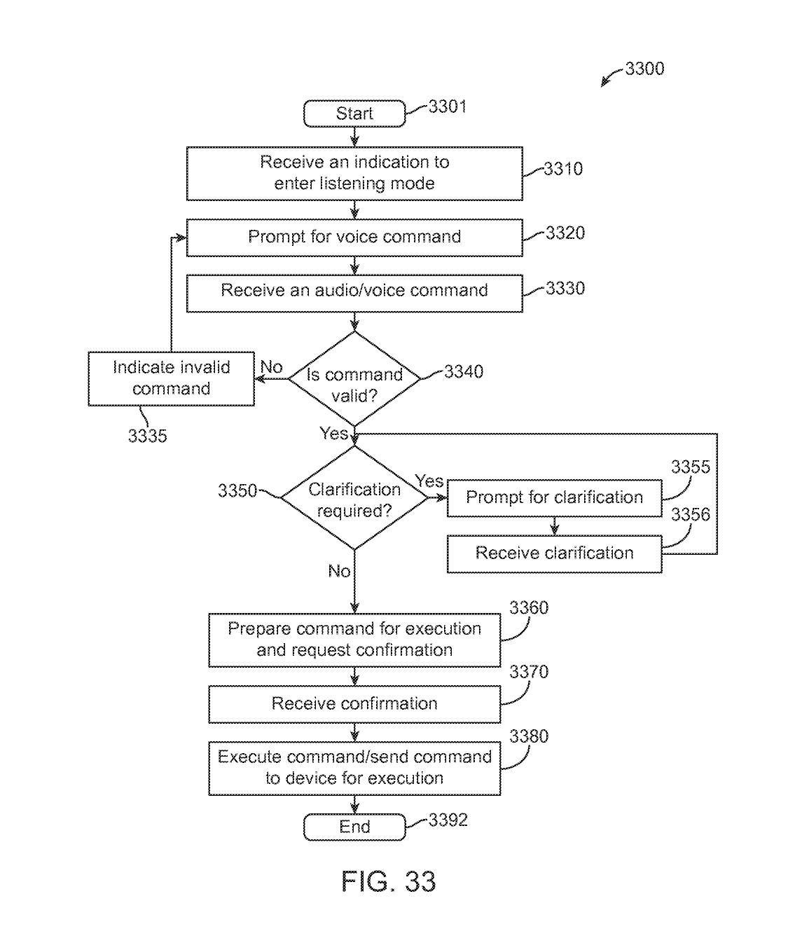

FIG. 33 shows an example process 3300 for receiving commands on a wearable device (e.g., wearable device 140, FIG. 2, FIG. 26, FIG. 32), according to one embodiment. In one embodiment, at any point in the process 3300, the user may interact with the touch screen to scroll to review commands. In one embodiment, in process 3300 the user may cancel out by pressing the physical button or use a specific cancellation touch/motion gesture. In one embodiment, the user may also provide confirmation by tapping the screen to accept a command when indicated.

In one embodiment, process 3300 begins at the start block 3301. In block 3310 an indication to enter a listening mode is received by the wearable device (e.g., wearable device 140, FIGS. 2, 26, 32). In block 3320 a user is prompted for a voice command from the wearable device. In block 3330 the wearable device receives an audio/voice command from a user. In block 3340 it is determined whether the voice command received is valid or not. If the voice command is determined to be invalid, process 3300 continues to block 3335 where the user is alerted to an invalid received command by the wearable device.

If it is determined that the voice command is valid, process 3300 proceeds to block 3350, where it is determined whether clarification is required or not. For the received voice command, if clarification for the voice command is required process 3300 proceeds to block 3355. In block 3355 the user is prompted for clarification by the wearable device.

In block 3356 the wearable device receives clarification via another voice command from the user. If it was determined that clarification of the voice command was not required, process 3300 proceeds to block 3360. In block 3360 the wearable device prepares the command for execution and the request confirmation. In block 3370 confirmation is received by the wearable device. In block 3380 process 3300 executes the command or the command is sent to the wearable device for execution. Process 3300 then proceeds to block 3392 and the process ends.

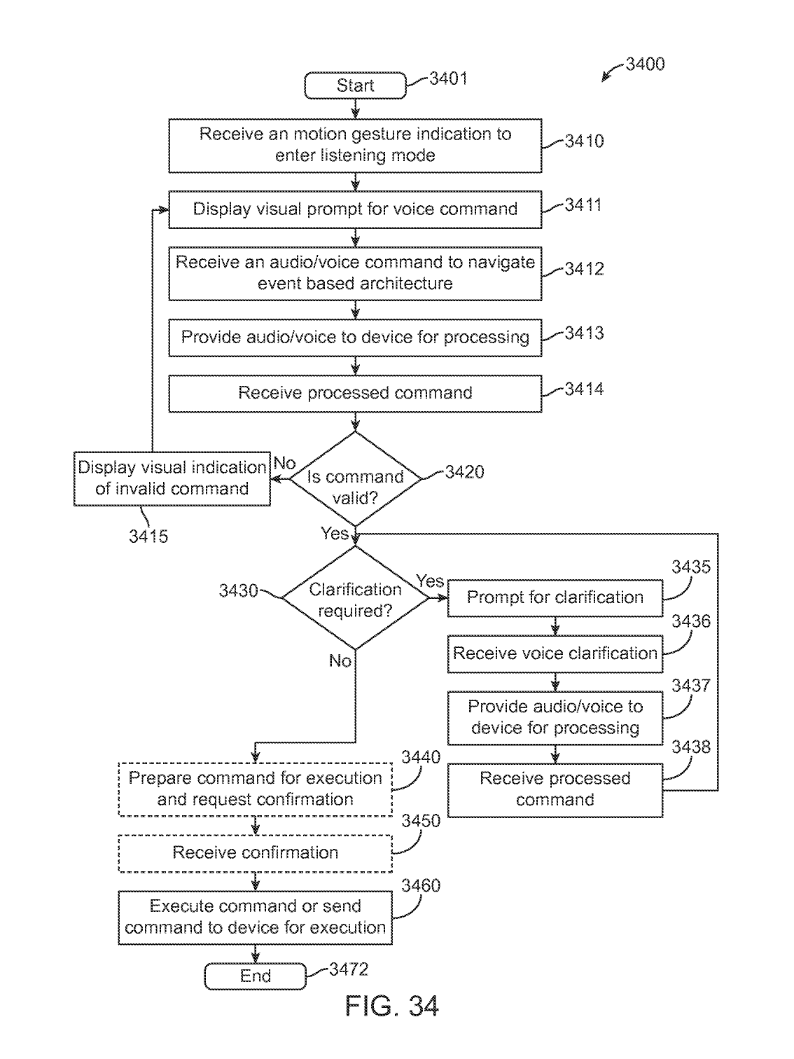

FIG. 34 shows an example process 3400 for motion based gestures for a mobile/wearable device, according to one embodiment. In one embodiment, process 3400 receives commands on the wearable device (e.g., wearable device 140, FIGS. 2, 26, 32) incorporating motion based gestures, such motion based gestures comprise the wearable device (e.g., a wristband) detecting a predetermined movement or motion of the wearable device 140 in response to the user's arm motion. In one embodiment, at any point in the process 3400 the user may interact with the touch screen to scroll for reviewing commands. In another embodiment, the scrolling may be accomplished through recognized motion gestures, such as rotating the wrist or other gestures which tilt or pan the wearable device. In one embodiment, the user may also cancel voice commands through various methods which may restart the process 3400 from the point of the canceled command, i.e., prompting for the command recently canceled. Additionally, after the displayed prompts, if no voice commands or other input is received within a predetermined interval of time (e.g., an idle period) the process may time out and automatically cancel.

In one embodiment, process 3400 begins at the start block 3401. In block 3410 a motion gesture indication to enter listening mode is received by the wearable device. In block 3411 a visual prompt for a voice command is displayed on the wearable device. In block 3412 audio/voice command to navigate the event-based architecture is received by the wearable device from a user. In block 3413 the audio/voice is provided to the wearable device (or the cloud 150, or host device (e.g., electronic device 120)) for processing.

In block 3414 the processed command is received. In block 3420 it is determined whether the voice command is valid. If it is determined that the voice command was not valid, process 3400 proceeds to block 3415 where a visual indication regarding the invalid command is displayed. In block 3430 it is determined whether clarification is required or not for the received voice command. If it was determined that clarification is required, process 3400 proceeds to block 3435 where the wearable device prompts for clarification from the user.

In block 3436 voice clarification is received by the wearable device. In block 3437 audio/voice is provided to the wearable device for processing. In block 3438 the process command is received. If it was determined that no clarification is required, process 3400 proceeds to optional block 3440. In optional block 3440 the command is prepared for execution and a request for confirmation is also prepared. In optional block 3450 confirmation is received. In optional block 3460 the command is executed or sent to the wearable device for execution. Process 3400 then proceeds to the end block 3472.

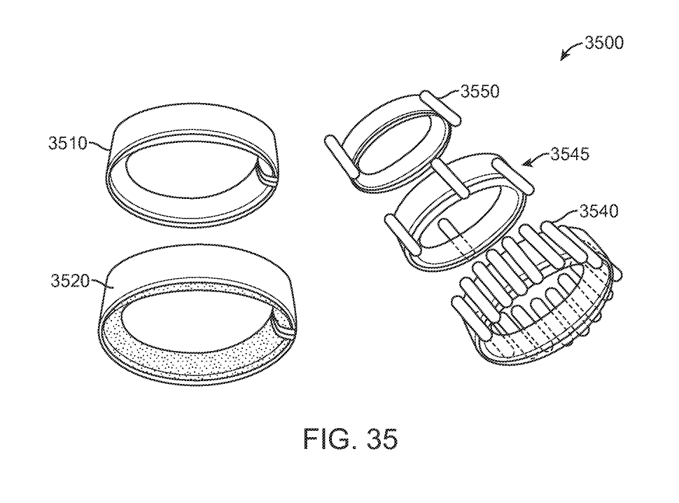

FIG. 35 shows examples 3500 of a smart alert wearable device 3510 using haptic elements 3540, according to one embodiment. In one embodiment, a haptic array or a plurality of haptic elements 3540 may be embedded within a wearable device 3510, e.g., a wristband. In one embodiment, this array may be customized by users for unique notifications cycled around the band for different portions of haptic elements 3540 (e.g., portions 3550, portions 3545, or all haptic elements 3540). In one embodiment, the cycled notifications may be presented in one instance as a chasing pattern around the haptic array where the user feels the motion move around the wrist.

In one embodiment, the different parts of the band of the wearable device 3510 may vibrate in a pattern, e.g., clockwise or counterclockwise around the wrist. Other patterns may include a rotating pattern where opposing sides of the band pulse simultaneously (e.g., the haptic portions 3550) then the next opposing set of haptic motor elements vibrate (e.g., the haptic portions 3545). In one example embodiment, top and bottom portions vibrate simultaneously, then both side portions, etc. In one example embodiment, the haptic elements 3550 of the smart alert wearable device 3510 show opposing sides vibrating for an alert. In another example embodiment, the haptic elements 3545 of the smart alert wearable device 3510 show four points on the band that vibrate for an alert. In one embodiment, the haptic elements 3540 of the smart alert wearable device 3510 vibrate in a rotation around the band.

In one embodiment, the pulsing of the haptic elements 3540 may be localized so the user may only feel one segment of the band pulse at a time. This may be accomplished by using the adjacent haptic element 3540 motors to negate vibrations in other parts of the band.

In one embodiment, in addition to customizable cycled notifications, the wearable device may have a haptic language, where specific vibration pulses or patterns of pulses have certain meanings. In one embodiment, the vibration patterns or pulses may be used to indicate a new state of the wearable device 3510. In one example embodiment, when important notifications or calls are received, differentiating the notifications, identifying message senders through unique haptic patterns, etc.

In one embodiment, the wearable device 3510 may comprise material more conducive to allowing the user to feel the effects of the haptic array. Such material may be a softer device to enhance the localized feeling. In one embodiment, a harder device may be used for a more unified vibration feeling or melding of the vibrations generated by the haptic array. In one embodiment, the interior of the wearable device 3510 may be customized as shown in wearable device 3520 to have a different type of material (e.g., softer, harder, more flexible, etc.).

In one embodiment, as indicated above, the haptic feedback array may be customized or programmed with specific patterns. The programming may take input using a physical force resistor sensor or using the touch interface. In one embodiment, the wearable device 3510 initiates and records a haptic pattern, using either mentioned input methods. In another embodiment, the wearable device 3510 may be configured to receive a nonverbal message from a specific person, a replication of tactile contact, such as a clasp on the wrist (through pressure, a slowly encompassing vibration, etc.). In one embodiment, the nonverbal message may be a unique vibration or pattern. In one example embodiment, a user may be able to squeeze their wearable device 3510 causing a preprogrammed unique vibration to be sent to a pre-chosen recipient, e.g., squeezing the band to send a special notification to a family member. In one embodiment, the custom vibration pattern may be accompanied with a displayed textual message, image, or special slide.

In one embodiment, various methods for recording the haptic pattern may be used. In one embodiment, a multi-dimensional haptic pattern comprising an array, amplitude, phase, frequency, etc., may be recorded. In one embodiment, such components of the pattern may be recorded separately or interpreted from a user input. In one embodiment, an alternate method may utilize a touch screen with a GUI comprising touch input locations corresponding to various actuators. In one example embodiment, a touch screen may map the x and y axis along with force input accordingly to the array of haptic actuators. In one embodiment, a multi-dimensional pattern algorithm or module may be used to compile the user input into a haptic pattern (e.g., utilizing the array, amplitude, phase, frequency, etc.). Another embodiment may consider performing the haptic pattern recording on a separate device from the wearable device 3510 (e.g., electronic device 120) using a recording program. In this embodiment, preset patterns may be utilized or the program may utilize intelligent algorithms to assist the user in effortlessly creating haptic patterns.

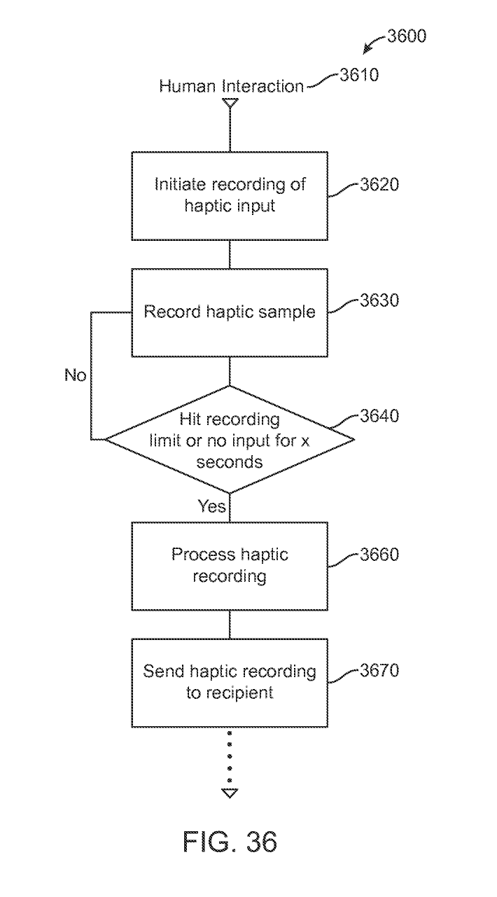

FIG. 36 shows an example process 3600 for recording a customized haptic pattern, according to one embodiment. In one embodiment, process 3600 may be performed on an external device (e.g., electronic device 120, cloud 150, etc.) and provided to the wearable device (e.g., wearable device 140 or 3510, FIGS. 2, 26, 32, 35). In one embodiment, the flow receives input indicating the initiation of the haptic input recording mode. In one embodiment, the initiation may include displaying a GUI or other UI to accept input commands for the customized recording. In one embodiment, the recording mode for receiving haptic input lasts until a preset limit or time is reached or no input is detected for a certain number of seconds (e.g., an idle period). In one embodiment, the haptic recording is then processed. The processing may include applying an algorithm to compile the haptic input into a unique pattern. In one example embodiment, the algorithm may transform a single input of force over a period of time to a unique pattern comprising a variance of amplitude, frequency and position (e.g., around the wristband). In one embodiment, the processing may include applying one or more filters to transform the input into a rich playback experience by enhancing or creatively changing characteristics of the haptic input. In one example embodiment, a filter may smooth out the haptic sample or apply a fading effect to the input. The processed recording may be sent or transferred to the recipient. The transfer may be done through various communications interface methods, such as Bluetooth®, WiFi, cellular, HTTP, etc. In one embodiment, the sending of the processed recording may comprise transferring a small message that is routed to a cloud backend, directed to a phone, and then routed over Bluetooth® to the wearable device.

In one embodiment, human interaction with a wearable device is provided at 3610. In block 3620 recording of haptic input is initiated. In block 3630 a haptic sample is recorded. In block 3640 is determined whether a recording limit has been reached or no input has been received for a particular amount of time (e.g., in seconds) has been received. If the recording limit has not been reached and input has been received, then process 3600 proceeds back to block 3630. If the recording limit has been reached or no input has been received for the particular amount of time, process 3600 proceeds to block 3660. In block 3660 the haptic recording is processed. In block 3670 the haptic recording is sent to the recipient. In one embodiment, process 3600 then proceeds back to block 3610 and repeats, flows into the process shown below, or ends.

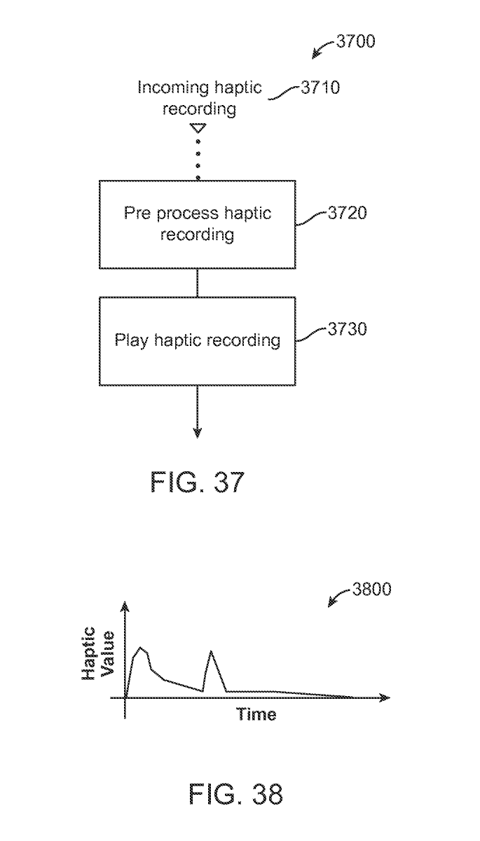

FIG. 37 shows an example process 3700 for a wearable device (e.g., wearable device 140 or 3510, FIGS. 2, 26, 32, 35) receiving and playing a haptic recording, according to one embodiment. In one embodiment, the incoming recording 3710 may be pre-processed in block 3720 to ensure it is playable on the wearable device, i.e., ensuring proper formatting, no loss/corruption from the transmission, etc. In one embodiment, the recording may then be played on the wearable device in block 3730 allowing the user to experience the created recording.

In one embodiment, the recording, processing, and playing may occur completely on a single device. In this embodiment, the sending may not be required. In one embodiment, the pre-processing in block 3720 may also be omitted. In one embodiment, a filtering block may be employed. In one embodiment, the filtering block may be employed to smooth out the signal. Other filters may be used to creatively add effects to transform a simple input to into a rich playback experience. In one example embodiment, a filter may be applied to alternatively fade and strengthen the recording as it travels around the wearable device band.

FIG. 38 shows an example diagram 3800 of a haptic recording, according to one embodiment. In one embodiment, the example diagram 3800 illustrates an exemplary haptic recording of a force over time. In one embodiment, other variables may be employed to allow creation of a customized haptic pattern. In one embodiment, the diagram 3800 shows a simplified haptic recording, where the haptic value might be just dependent on the force, but also a complex mix of frequency, amplitude and position. In one embodiment, the haptic recording may also be filtered according to different filters, to enhance or creatively change the characteristics of the signal.

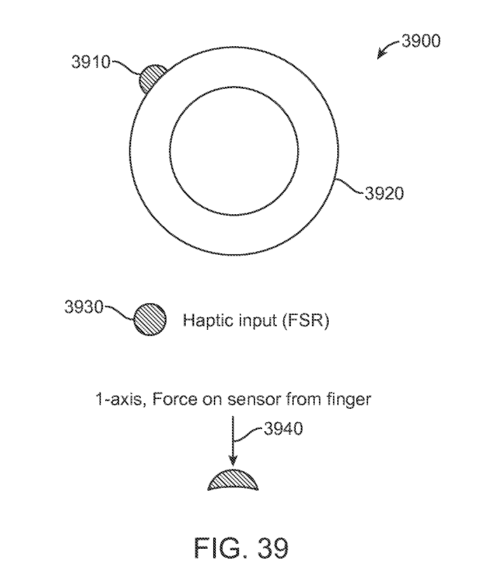

FIG. 39 shows an example 3900 of a single axis force sensor 3910 of a wearable device 3920 (e.g., similar to wearable device 140 or 3510, FIGS. 2, 26, 32, 35) for recording haptic input 3930, according to one embodiment. In one embodiment, the haptic sensor 3910 may recognize a single type of input, e.g., force on the sensor from the finger 3940. In one example embodiment, with a single haptic input 3930, the haptic recording may be shown as a force over time diagram similar to diagram 3800, FIG. 38).

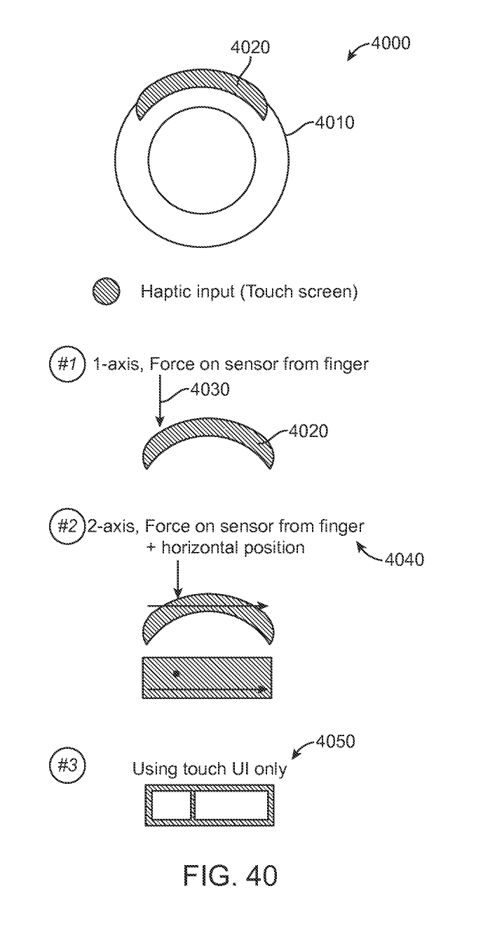

FIG. 40 shows an example 4000 of a touch screen 4020 for haptic input for a wearable device 4010 (e.g., similar to wearable device 140, FIGS. 2, 26, 32, 3510, FIG. 35, 3920, FIG. 39), according to one embodiment. In one embodiment, multiple ways to recognize haptic inputs are employed. In one example embodiment, one type of haptic input recognized may be the force 4030 on the sensor by a user's finger. In one example embodiment, another type of haptic input 4040 may include utilizing both the touchscreen 4020 and the force 4030 on the sensor. In this haptic input, the x and y position on the touchscreen 4020 can be recognized in addition to the force 4030. This may allow for a freeform approach where an algorithm may take the position and compose a haptic signal. In one example embodiment, a third type of haptic input 4050 may be performed solely using a GUI on the touch screen 4020. This input type may comprise using buttons displayed by the GUI for different signals, tones, or effects. In one embodiment, the GUI may comprise a mix of buttons and a track pad for additional combinations of haptic input.

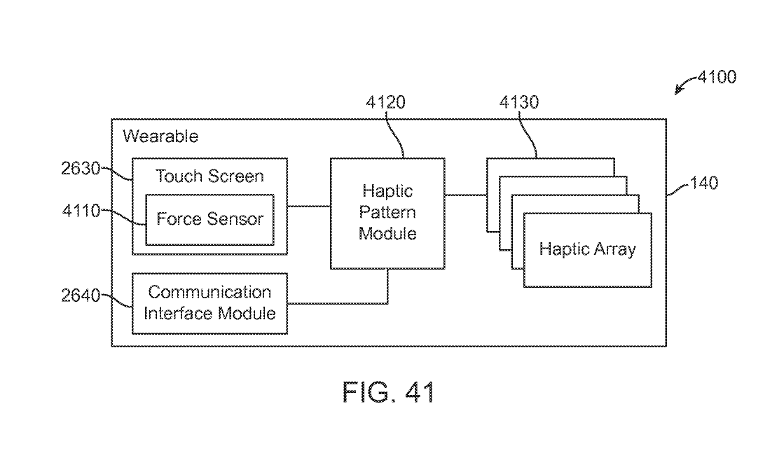

FIG. 41 shows an example block diagram for a wearable device 140 system 4100, according to one embodiment. In one embodiment, the touch screen 2630, force sensor 4110, and haptic array 4130 may perform functions as described above. In one embodiment, the communication interface module 2640 may connect with other devices through various communication interface methods, e.g., Bluetooth®, NFC, WiFi, cellular, etc., allowing for the transfer or receipt of data. In one embodiment, the haptic pattern module 4120 may control the initiating and recording of the haptic input along with playback of the haptic input on the haptic array 4130. In one example embodiment, the haptic pattern module 4120 may also perform the processing of the recorded input as described above. In this embodiment, the haptic pattern module 4120 may comprise an algorithm for creatively composing a haptic signal, i.e., converting position and force to a haptic signal that plays around the wearable device 140 band. In one embodiment, the haptic pattern module 4120 may also send haptic patterns to other devices or receive haptic patterns to play on the wearable device 140 through the communication interface module 2640.

FIG. 42 shows a block diagram 4200 of a process for contextualizing and presenting user data, according to one embodiment. In one embodiment, in block 4210 the process includes collecting information including service activity data and sensor data from one or more electronic devices. Block 4220 provides organizing the information based on associated time for the collected information. In block 4230, one or more of content information and service information of potential interest to the one or more electronic devices is provided based on one or more of user context and user activity.

In one embodiment, process 4200 may include filtering the organized information based on one or more selected filters. In one example, the user context is determined based on one or more of location information, movement information and user activity. The organized information may be presented in a particular chronological order on a graphical timeline. In one example embodiment, providing one or more of content and services of potential interest comprises providing one or more of alerts, suggestions, events and communications to the one or more electronic devices.

In one example, the content information and the service information are user subscribable for use with the one or more electronic devices. In one embodiment, the organized information is dynamically delivered to the one or more electronic devices. In one example, the service activity data, the sensor data and content may be captured as a flagged event based on a user action. The sensor data from the one or more electronic devices and the service activity data may be provided to one or more of a cloud based system and a network system for determining the user context. In one embodiment, the user context is provided to the one or more electronic devices for controlling one or more of mode activation and notification on the one or more electronic devices.

In one example, the organized information is continuously provided and comprises life event information collected over a timeline. The life event information may be stored on one or more of a cloud based system, a network system and the one or more electronic devices. In one embodiment, the one or more electronic devices comprise mobile electronic devices, and the mobile electronic devices comprise one or more of: a mobile telephone, a wearable computing device, a tablet device, and a mobile computing device.

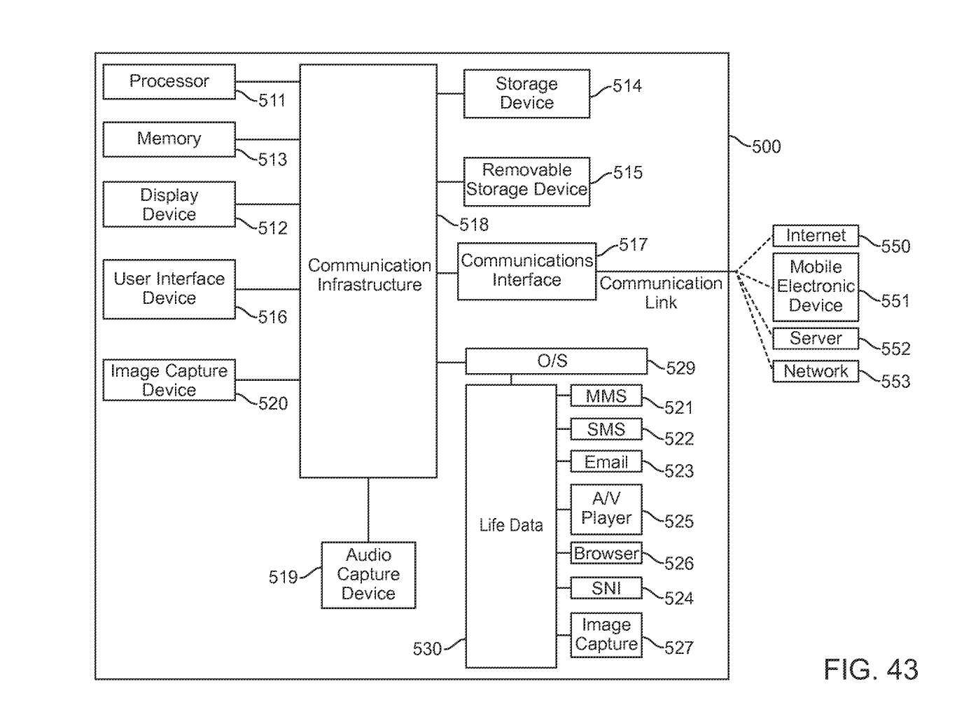

FIG. 43 is a high-level block diagram showing an information processing system comprising a computing system 500 implementing one or more embodiments. The system 500 includes one or more processors 511 (e.g., ASIC, CPU, etc.), and may further include an electronic display device 512 (for displaying graphics, text, and other data), a main memory 513 (e.g., random access memory (RAM), cache devices, etc.), storage device 514 (e.g., hard disk drive), removable storage device 515 (e.g., removable storage drive, removable memory module, a magnetic tape drive, optical disk drive, computer-readable medium having stored therein computer software and/or data), user interface device 516 (e.g., keyboard, touch screen, keypad, pointing device), and a communication interface 517 (e.g., modem, wireless transceiver (such as Wi-Fi, Cellular), a network interface (such as an Ethernet card), a communications port, or a PCMCIA slot and card).

The communication interface 517 allows software and data to be transferred between the computer system and external devices through the Internet 550, mobile electronic device 551, a server 552, a network 553, etc. The system 500 further includes a communications infrastructure 518 (e.g., a communications bus, cross bar, or network) to which the aforementioned devices/modules 511 through 517 are connected.

The information transferred via communications interface 517 may be in the form of signals such as electronic, electromagnetic, optical, or other signals capable of being received by communications interface 517, via a communication link that carries signals and may be implemented using wire or cable, fiber optics, a phone line, a cellular phone link, an radio frequency (RF) link, and/or other communication channels.

In one implementation of one or more embodiments in a mobile wireless device (e.g., a mobile phone, smartphone, tablet, mobile computing device, wearable device, etc.), the system 500 further includes an image capture device 520, such as a camera 128 (FIG. 2), and an audio capture device 519, such as a microphone 122 (FIG. 2). The system 500 may further include application modules as MMS module 521, SMS module 522, email module 523, social network interface (SNI) module 524, audio/video (AV) player 525, web browser 526, image capture module 527, etc.

In one embodiment, the system 500 includes a life data module 530 that may implement a timeline system 300 processing similar as described regarding (FIG. 3), and components in block diagram 100 (FIG. 2). In one embodiment, the life data module 530 may implement the system 300 (FIG. 3), 400 (FIG. 4), 1400 (FIG. 14), 1800 (FIG. 18), 3200 (FIG. 32), 3500 (FIG. 35), 4100 (FIG. 41) and flow diagrams 1500 (FIG. 15), 1600 (FIG. 16), 2500 (FIG. 25), 2900 (FIG. 29), 3300 (FIG. 33), 3400 (FIG. 34) and 3600 (FIG. 36). In one embodiment, the life data module 530 along with an operating system 529 may be implemented as executable code residing in a memory of the system 500. In another embodiment, the life data module 530 may be provided in hardware, firmware, etc.

As is known to those skilled in the art, the aforementioned example architectures described above, according to said architectures, can be implemented in many ways, such as program instructions for execution by a processor, as software modules, microcode, as computer program product on computer readable media, as analog/logic circuits, as application specific integrated circuits, as firmware, as consumer electronic devices, AV devices, wireless/wired transmitters, wireless/wired receivers, networks, multi-media devices, etc. Further, embodiments of said Architecture can take the form of an entirely hardware embodiment, an entirely software embodiment or an embodiment containing both hardware and software elements.

One or more embodiments have been described with reference to flowchart illustrations and/or block diagrams of methods, apparatus (systems) and computer program products according to one or more embodiments. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic, implementing one or more embodiments. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer program instructions representing the block diagram and/or flowcharts herein may be loaded onto a computer, programmable data processing apparatus, or processing devices to cause a series of operations performed thereon to produce a computer implemented process. Computer programs (i.e., computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system. A computer program product comprises a tangible storage medium readable by a computer system and storing instructions for execution by the computer system for performing a method of one or more embodiments.

Though the embodiments have been described with reference to certain versions thereof; however, other versions are possible. Therefore, the spirit and scope of the appended claims should not be limited to the description of the preferred versions contained herein.

What is claimed is:

1. A method for contextualizing and presenting user data comprising:
collecting information comprising service activity data and sensor data from one or more electronic devices;
organizing the information based on associated time for the collected information; and
providing one or more of content information and service information of potential interest to the one or more electronic devices based on one or more of user context and user activity.

2. The method of claim 1, further comprising:
filtering the organized information based on one or more selected filters.

3. The method of claim 2, wherein the user context is determined based on one or more of location information, movement information and user activity.

4. The method of claim 3, wherein the organized information is presented in a particular chronological order on a graphical timeline.

5. The method of claim 3, wherein providing one or more of content and services of potential interest comprises providing one or more of alerts, suggestions, events and communications to the one or more electronic devices.

6. The method of claim 5, wherein the content information and the service information are user subscribable for use with the one or more electronic devices.

7. The method of claim 5, wherein the organized information is dynamically delivered to the one or more electronic devices.

8. The method of claim 1, wherein the service activity data, the sensor data and content are captured as a flagged event based on a user action.

9. The method of claim 1, wherein the sensor data from the one or more electronic devices and the service activity data are provided to one or more of a cloud based system and a network system for determining the user context, wherein the user context is provided to the one or more electronic devices for controlling one or more of mode activation and notification on the one or more electronic devices.

10. The method of claim 1, wherein the organized information is continuously provided and comprises life event information collected over a timeline, wherein the life event information is stored on one or more of a cloud based system, a network system and the one or more electronic devices.

11. The method of claim 1, wherein the one or more electronic devices comprise mobile electronic devices, and the mobile electronic devices comprise one or more of: a mobile telephone, a wearable computing device, a tablet device, and a mobile computing device.

12. A system comprising:
an activity module configured to collect information comprising service activity data and sensor data;
an organization module configured to organize the information based on associated time for the collected information; and
an information analyzer module configured to provide one or more of content information and service information of potential interest to one or more electronic devices based on one or more of user context and user activity.

13. The system of claim 12, wherein the organization module provides filtering of the organized information based on one or more selected filters.

14. The system of claim 13, wherein:
the user context is determined by the information analyzer module based on one or more of location information, movement information and user activity; and
the organized information is presented in a particular chronological order on a graphical timeline on the one or more electronic devices.

15. The system of claim 14, wherein the one or more of content information and service information of potential interest comprise one or more of: alerts, suggestions, events and communications.

16. The system of claim 15, wherein the content information and the service information are user subscribable for use with the one or more electronic devices.

17. The system of claim 12, wherein one or more electronic devices include multiple haptic elements for providing a haptic signal.

18. The system of claim 12, wherein the service activity data, the sensor data and content are captured as a flagged event in response to receiving a recognized user action on the one or more electronic devices.

19. The system of claim 12, wherein the sensor data from the one or more electronic devices and the service activity data are provided to the information analyzer module that executes on one or more of a cloud based system and a network system for determining the user context, wherein the user context is provided to the one or more electronic devices for controlling one or more of mode activation and notification on the one or more electronic devices.

20. The system of claim 12, wherein the organized information is continuously presented and comprises life event information collected over a timeline, wherein the life event information is stored on one or more of a cloud based system, a network system and the one or more electronic devices.

21. The system of claim 12, wherein the one or more electronic devices comprises mobile electronic devices, and the mobile electronic devices comprise one or more of: a mobile telephone, a wearable computing device, a tablet device, and a mobile computing device.

22. A non-transitory computer-readable medium having instructions which when executed on a computer perform a method comprising:
collecting information comprising service activity data and sensor data from one or more electronic devices;
organizing the information based on associated time for the collected information; and
providing one or more of content information and service information of potential interest to the one or more electronic devices based on one or more of user context and user activity.

23. The medium of claim 22, further comprising:
filtering the organized information based on one or more selected filters;
wherein the user context is determined based on one or more of location information, movement information and user activity.

24. The medium of claim 23, wherein:
the organized information is presented in a particular chronological order on a graphical timeline; and
providing one or more of content information and service information of potential interest comprises providing one or more of alerts, suggestions, events and communications to the one or more electronic devices.

25. The medium of claim 24, wherein:
the content information and service information are user subscribable for use with the one or more electronic devices;
the organized information is dynamically delivered to the one or more electronic devices; and
the service activity data, the sensor data and content are captured as a flagged event based on a user action.

26. The medium of claim 22, wherein the sensor data from the one or more electronic devices and the service activity data are provided to one or more of a cloud based system and a network system for determining the user context, wherein the user context is provided to the one or more electronic devices for controlling one or more of mode activation and notification on the one or more electronic devices.

27. The medium of claim 22, wherein the organized information is continuously presented and comprises life event information collected over a timeline, wherein the life event information is stored on one or more of a cloud based system, a network system and the one or more electronic devices.

28. The medium of claim 22, wherein the one or more electronic devices comprises mobile electronic devices, and the mobile electronic devices comprise one or more of: a mobile telephone, a wearable computing device, a tablet device, and a mobile computing device.

29. A graphical user interface (GUI) displayed on a display of an electronic device, comprising:
one or more timeline events related to information comprising service activity data and sensor data collected from at least the electronic device; and
one or more of content information and selectable service categories of potential interest to a user that are based on one or more of user context and user activity associated with the one or more timeline events.

30. The GUI of claim 29, wherein:
one or more icons are selectable for displaying one or more categories associated with the one or more timeline events; and
one or more of suggested content information and service information of interest to a user are provided on the GUI.

31. A display architecture for an electronic device comprising:
a timeline comprising a plurality of content elements and one or more content elements of potential user interest,
wherein the plurality of time-based elements comprise one or more of event information, communication information and contextual alert information, and the plurality of time-based elements are displayed in a particular chronological order, and
wherein the plurality of time-based elements are expandable to provide expanded information based on a received recognized user action.

32. A wearable electronic device comprising:
a processor;
a memory coupled to the processor;
a curved display; and
one or more sensors that provides sensor data to an analyzer module that determines context information and provides one or more of content information and service information of potential interest to a timeline module of the wearable electronic device using the context information that is determined based on the sensor data and additional information received from one or more of service activity data and additional sensor data from a paired host electronic device, wherein the timeline module organizes content for a timeline interface on the curved display.
